(19) United States
(12) Patent Application Publication
(10) Pub. No.: US 2018/0176639 A1
(43) Pub. Date: Jun. 21, 2018

(54) Method and System for Implementing Advanced Audio Shifting

(71) Applicant: CenturyLink Intellectual Property LLC, Denver, CO (US)

(72) Inventors: Michael D. Sprenger, Boulder, CO (US); Zubin Ingah, Centennial, CO (US)

(21) Appl. No.: 15/477,812

(22) Filed: Apr. 3, 2017

Related U.S. Application Data
(60) Provisional application No. 62/435,992, filed on Dec. 19, 2016.

(51) Int. Cl. H04N 21/439; G06F 3/16; H04N 5/60

(52) U.S. Cl. CPC H04N 21/4396; G10H 2250/035; H04N 5/602; G06F 3/165

(57) ABSTRACT

Novel tools and techniques are provided for implementing media content streaming or playback, and, more particularly, for implementing advanced audio shifting. In various embodiments, a computing system might present a first audio content to a user using at least one audio playback device. The computing system might receive user input from the user, the user input being indicative of a desire by the user to switch from presentation of the first audio content to presentation of a second audio content. In response to receiving the user input, the computing system might automatically shift from presentation of the first audio content to presentation of the second audio content using an audio shift using the at least one audio playback device, the audio shift comprising a gradual decrease in volume of the first audio content to mute followed by a gradual increase in volume of the second audio content from mute.

### CROSS-REFERENCES TO RELATED APPLICATIONS

This application claims priority to U.S. Patent Application Ser. No. 62/435,992 (the “'992 application”), filed Dec. 19, 2016 by Michael D. Sprenger et al. (attorney docket no. 020370-031901US), entitled, “Advanced Audio Fading Mechanism,” the disclosure of which is incorporated herein by reference in its entirety for all purposes.

This application may be related to U.S. patent application Ser. No. 15/477,376 (the “'376 application”), filed on a date even herewith by Zubin Ingah et al. (attorney docket no. 020370-030900US), entitled, “Method and System for Implementing Content Navigation or Selection Using Touch-based Input,” which claims priority to U.S. Patent Application Ser. No. 62/403,843 (the “'843 application”), filed Oct. 4, 2016 by Zubin Ingah et al. (attorney docket no. 020370-030901US), entitled, “Novel Mechanism for Content Selection Using Touchscreen or Touchpad,” the disclosures of both of which are incorporated herein by reference in their entirety for all purposes.

The respective disclosures of these applications/patents (which this document refers to collectively as the “Related Applications”) are incorporated herein by reference in their entirety for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to methods, systems, and apparatuses for implementing media content streaming or playback, and, more particularly, to methods, systems, and apparatuses for implementing advanced audio shifting.

### BACKGROUND

In conventional media playback systems, when changing channels on display devices (e.g., televisions (“TVs”) or the like) or when selecting different audio inputs (or audio and video inputs) on media players or other consumer electronics devices, users often hear noticeable popping, cracking, or crackling sounds. These sounds result from the sudden switch from one content source to another. The conventional approach of completely turning off and on the volume (i.e., a “hard mute” or the like) during channel changes or during switching of at least audio inputs in response to user selection does not completely address the inherent problem and the switch from one (audio) source to another is still very sudden. Such sudden audio switching can still result in the noticeable popping, cracking, or crackling sounds.

Hence, there is a need for more robust and scalable solutions for implementing media content streaming or playback, and, more particularly, to methods, systems, and apparatuses for implementing advanced audio shifting.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is a schematic diagram illustrating a system for implementing advanced audio shifting, in accordance with various embodiments.

FIGS. 2A and 2B are graphical diagrams illustrating some examples of a conventional audio muting approach.

FIGS. 3A-3H are graphical diagrams illustrating various embodiments for implementing advanced audio shifting.

FIG. 4 is a flow diagram illustrating a method for implementing advanced audio shifting, in accordance with various embodiments.

FIGS. 5A-5J are graphical diagrams illustrating various embodiments for implementing advanced audio shifting concurrent with video shifting.

FIG. 6 is a flow diagram illustrating a method for implementing advanced audio shifting concurrent with video shifting, in accordance with various embodiments.

FIG. 7 is a block diagram illustrating an exemplary computer or system hardware architecture, in accordance with various embodiments.

FIG. 8 is a block diagram illustrating a networked system of computers, computing systems, or system hardware architecture, which can be used in accordance with various embodiments.

### DETAILED DESCRIPTION OF CERTAIN EMBODIMENTS

Overview

Various embodiments provide tools and techniques for implementing media content streaming or playback, and, more particularly, to methods, systems, and apparatuses for implementing advanced audio shifting.

In various embodiments, one of a computing system, a display device, a user device, or at least one audio playback device might present a first audio content to a user using the at least one audio playback device. At least one of the computing system, the display device, the user device, or the at least one audio playback device might receive user input from the user, the user input being indicative of a desire by the user to switch from presentation of the first audio content to presentation of a second audio content. In response to receiving the user input, the at least one of the computing system, the display device, the user device, or the at least one audio playback device might automatically shift from presentation of the first audio content to presentation of the second audio content using an audio shift using the at least one audio playback device, the audio shift comprising a gradual decrease in volume of the first audio content to mute followed by a gradual increase in volume of the second audio content from mute. Some embodiments may approximate the gradual audio shift via a number of suitably small discrete steps in volume level change.

In some embodiments, the gradual decrease in volume of the first audio content and the corresponding gradual increase in volume of the second audio content might comprise one of a mirrored pair of linear ramp waveforms, a mirrored pair of non-linear waveforms (e.g., S-curved waveforms, non-S-curved waveforms, or the like), and/or the like. In some cases, the volume of the second audio content after the gradual increase in volume might match the volume of the first audio content prior to the gradual decrease in volume. Alternatively, the volume of the second audio content after the gradual increase in volume might differ from the volume of the first audio content prior to the gradual decrease in volume.

According to some embodiments, the automatic shifting from presentation of the first audio content to presentation of the second audio content on the at least one audio playback device might be initiated after the volume of the first audio content is fully muted, while the gradual increase in volume of the second audio content might be initiated after completion of the automatic shifting from presentation of the first audio content to presentation of the second audio content on the at least one audio playback device. Alternatively, the automatic shifting from presentation of the first audio content to presentation of the second audio content on the at least one audio playback device might be initiated during the gradual decrease in volume of the first audio content and before the volume of the first audio content is fully muted, and the increase in volume of the second audio content might be initiated before the automatic shifting from presentation of the first audio content to presentation of the second audio content on the at least one audio playback device has been completed.

In some aspects, the system might provide users with options to select the time constant (i.e., the ramp-down times and the ramp-up times, the decrease volume times and the increase volume times, etc.) for decreasing and increasing the volume, according to user or personal preferences. In some cases, the system might also provide the user with options to completely turn the audio shifting feature off, if the user prefers not to use it. Here, the term “user” can include, without limitation, an end user, an operator providing service, or any other entity. In some embodiments, the system might implement an auto-adjustable fading technique or mechanism, where the time constants for ramp-down (or volume decrease) and for ramp-up (or volume increase) might depend on the channel or content changing time, which can be variable in some systems.

Merely by way of example, in some embodiments, automatically shifting from presentation of the first audio content to presentation of the second audio content using the audio shift using the audio playback device might include, without limitation, automatically shifting from presentation of the first audio content to presentation of the second audio content using one of a simple multiplication in digital domain, dithering volume control in digital domain, adjusting the gain of an amplification stage (e.g., via adjustment of suitable resistor values in an amplifier's negative feedback loop, or the like), or in the analog domain using analog switches and a stepped resistor network to implement the audio shift, and/or the like.

For embodiments in which audio shifting is implemented concurrently with video shifting (e.g., channel changing, switching between input streams in video streaming applications, switching between video content in DVR or other video recording/playback applications, or video shifting or content selection/navigation as described in detail in the '376 application (which has already been incorporated herein by reference in its entirety for all purposes), and/or the like), one of the computing system, the display device, the user device, or the at least one audio playback device might display a first video content to the user on the display device while concurrently presenting (in a time/frame-matched manner) a first audio content corresponding to the first video content to the user using the at least one audio playback device. At least one of the computing system, the display device, the user device, or the at least one audio playback device might receive user input from the user, the user input being indicative of a desire by the user to switch from display of the first video content to display of a second video content on the display device (and further indicative of a desire by the user to switch from presentation of the first audio content to presentation of a second audio content, which corresponds to the second video content). In response to receiving the user input, the at least one of the computing system, the display device, the user device, or the at least one audio playback device might automatically shift from presentation of the first audio content to presentation of the second audio content using an audio shift using the at least one audio playback device, the audio shift comprising a gradual decrease in volume of the first audio content to mute followed by a gradual increase in volume of the second audio content from mute.

In some embodiments, the gradual decrease in volume of the first audio content and the corresponding gradual increase in volume of the second audio content might comprise one of a mirrored pair of linear ramp waveforms, a mirrored pair of non-linear waveforms (e.g., S-curved waveforms, non-S-curved waveforms, or the like), and/or the like. In some cases, the volume of the second audio content after the gradual increase in volume might match the volume of the first audio content prior to the gradual decrease in volume. Alternatively, the volume of the second audio content after the gradual increase in volume might differ from the volume of the first audio content prior to the gradual decrease in volume. Further in response to receiving the user input, the at least one of the computing system, the display device, the user device, or the at least one audio playback device might automatically shift from display of the first video content to display of the second video content on the display device, concurrent with automatically shifting from presentation of the first audio content to presentation of the second audio content using the audio shift using the audio playback device.

According to some embodiments, the automatic shifting from display of the first video content to display of the second video content on the display device might be initiated after the volume of the first audio content is fully muted, while the gradual increase in volume of the second audio content might be initiated after completion of the automatic shifting from display of the first video content to display of the second video content on the display device. Alternatively, the automatic shifting from display of the first video content to display of the second video content on the display device might be initiated during the gradual decrease in volume of the first audio content and before the volume of the first audio content is fully muted, and the increase in volume of the second audio content might be initiated before the automatic shifting from display of the first video content to display of the second video content on the display device has been completed.

Merely by way of example, in some embodiments, automatically shifting from presentation of the first audio content to presentation of the second audio content using the audio shift using the audio playback device might include, without limitation, automatically shifting from presentation of the first audio content to presentation of the second audio content using one of a simple multiplication in digital domain, dithering volume control in digital domain, adjusting the gain of an amplification stage (e.g., via adjustment of suitable resistor values in an amplifier's negative feedback loop, or the like), or in the analog domain using analog switches and a stepped resistor network to implement the audio shift, and/or the like.

The following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

Various embodiments described herein, while embodying (in some cases) software products, computer-performed methods, and/or computer systems, represent tangible, concrete improvements to existing technological areas, including, without limitation, media content streaming or downloading technology, media content navigation or selection technology, user interface technology, audio playback technology, and/or the like. In other aspects, certain embodiments, can improve the functioning of user equipment or systems themselves (e.g., media players, set-top boxes (“STBs”), media content streaming or downloading systems, audio playback devices, etc.), for example, by, in response to receiving user input to change at least audio inputs or audio content, automatically shift from presentation of a first audio content to presentation of a second audio content using an audio shift using at least one audio playback device, the audio shift comprising a gradual decrease in volume of the first audio content to mute followed by a gradual increase in volume of the second audio content from mute, and/or the like. In particular, to the extent any abstract concepts are present in the various embodiments, those concepts can be implemented as described herein by devices, software, systems, and methods that involve specific novel functionality (e.g., steps or operations), such as, in response to receiving user input to change at least audio inputs or audio content, automatically shift from presentation of a first audio content to presentation of a second audio content using an audio shift using at least one audio playback device, the audio shift comprising a gradual decrease in volume of the first audio content to mute followed by a gradual increase in volume of the second audio content from mute, and/or the like, which optimizes presentation of the audio content thus providing for smoother and less audibly jarring shifting of audio content, and/or the like, to name a few examples, that extend beyond mere conventional computer processing operations. These functionalities can produce tangible results outside of the implementing computer system, including, merely by way of example, optimized presentation and switching of audio content to the user thus providing for smoother and less audibly jarring changing of audio content, and/or the like, at least some of which may be observed or measured by customers and/or service providers.

In an aspect, a method might comprise presenting, with a computing system, a first audio content to a user using an audio playback device; and receiving, with the computing system, user input from the user, the user input being indicative of a desire by the user to switch from presentation of the first audio content to presentation of a second audio content. The method might further comprise, in response to receiving the user input, automatically shifting, with the computing system, from presentation of the first audio content to presentation of the second audio content using an audio shift using the audio playback device, the audio shift comprising a gradual decrease in volume of the first audio content to mute followed by a gradual increase in volume of the second audio content from mute.

In some embodiments, the gradual decrease in volume of the first audio content and the corresponding gradual increase in volume of the second audio content might comprise one of a mirrored pair of linear ramp waveforms, a mirrored pair of S-curved waveforms, or a mirrored pair of non-S-curved waveforms, and/or the like. In some cases, the volume of the second audio content after the gradual increase in volume might match the volume of the first audio content prior to the gradual decrease in volume.

According to some embodiments, the method might further comprise displaying, with the computing system, a first video content to the user on a display device, the first audio content corresponding to the first video content, wherein the user input is further indicative of a desire by the user to switch from display of the first video content to display of a second video content on the display device, the second audio content corresponding to the second video content; and further in response to receiving the user input, automatically shifting, with the computing system, from display of the first video content to display of the second video content on the display device, concurrent with automatically shifting from presentation of the first audio content to presentation of the second audio content using the audio shift using the audio playback device.

In some cases, the automatic shifting from display of the first video content to display of the second video content on the display device might be initiated during the gradual decrease in volume of the first audio content and before the volume of the first audio content is fully muted. Alternatively, the automatic shifting from display of the first video content to display of the second video content on the display device might be initiated after the volume of the first audio content is fully muted, while the gradual increase in volume of the second audio content might be initiated after completion of the automatic shifting from display of the first video content to display of the second video content on the display device. In some instances, each of the first video content and the second video content might comprise video content that is broadcast on a broadcast channel. Alternatively, each of the first video content and the second video content might comprise video content among a plurality of video content available for browsing or viewing in one of a video on demand (“VoD”) platform, a video streaming platform, or a digital video recording (“DVR”) platform, and/or the like.

Merely by way of example, in some embodiments, automatically shifting from presentation of the first audio content to presentation of the second audio content using the audio shift using the audio playback device might comprise automatically shifting, with the computing system, from presentation of the first audio content to presentation of the second audio content using one of a simple multiplication in digital domain, dithering volume control in digital domain, adjusting the gain of an amplification stage (e.g., via adjustment of suitable resistor values in an amplifier's negative feedback loop, or the like), or in the analog domain using analog switches and a stepped resistor network to implement the audio shift, and/or the like.

According to some embodiments, the computing system might comprise one of a processor of a set-top box, a processor of a digital video recording (“DVR”) device, a processor of a display device running a software application (“app”), a processor of the audio playback device, a processor on a user device running an app, a processor of a media player, a processor of a gaming console, a processor in sound studio audio equipment, a processor in video editing equipment, a processor in broadcast equipment, a processor in a video head-end, a processor in audio equipment associated with a sound reinforcement installation, a processor in audio equipment associated with a public address system, a server computer over a network, or a cloud-based computing system over a network, and/or the like. In some embodiments, the audio playback device might comprise one or more speakers external to but communicatively coupled to a display device, one of one or more speakers of the display device, one or more speakers external to but communicatively coupled to the computing system, one or more speakers of the computing system, one or more speakers external to but communicatively coupled to a user device, one or more speakers of the user device, one or more headphones, one or more earbuds, one or more sound bars, one or more wireless speakers, or one or more stereo speakers, and/or the like.

In another aspect, an apparatus might comprise at least one processor and a non-transitory computer readable medium communicatively coupled to the at least one processor. The non-transitory computer readable medium might have stored thereon computer software comprising a set of instructions that, when executed by the at least one processor, causes the apparatus to: present a first audio content to a user using an audio playback device; receive user input from the user, the user input being indicative of a desire by the user to switch from presentation of the first audio content to presentation of a second audio content; and in response to receiving the user input, automatically shift from presentation of the first audio content to presentation of the second audio content using an audio shift using the audio playback device, the audio shift comprising a gradual decrease in volume of the first audio content to mute followed by a gradual increase in volume of the second audio content from mute.

In some embodiments, the gradual decrease in volume of the first audio content and the corresponding gradual increase in volume of the second audio content might comprise one of a mirrored pair of linear ramp waveforms, a mirrored pair of S-curved waveforms, or a mirrored pair of non-S-curved waveforms, and/or the like. In some cases, the volume of the second audio content after the gradual increase in volume might match the volume of the first audio content prior to the gradual decrease in volume.

According to some embodiments, the set of instructions, when executed by the at least one processor, might further cause the apparatus to: display a first video content to the user on a display device, the first audio content corresponding to the first video content, wherein the user input is further indicative of a desire by the user to switch from display of the first video content to display of a second video content on the display device, the second audio content corresponding to the second video content; and further in response to receiving the user input, automatically shift from display of the first video content to display of the second video content on the display device, concurrent with automatically shifting from presentation of the first audio content to presentation of the second audio content using the audio shift using the audio playback device.

In some cases, the automatic shifting from display of the first video content to display of the second video content on the display device might be initiated during the gradual decrease in volume of the first audio content and before the volume of the first audio content is fully muted. Alternatively, the automatic shifting from display of the first video content to display of the second video content on the display device might be initiated after the volume of the first audio content is fully muted, while the gradual increase in volume of the second audio content might be initiated after completion of the automatic shifting from display of the first video content to display of the second video content on the display device. In some cases, the display device might comprise one of a television set, a smart television, a computer monitor, or a laptop monitor, and/or the like. In some instances, each of the first video content and the second video content might comprise video content that is broadcast on a broadcast channel. Alternatively, each of the first video content and the second video content might comprise video content among a plurality of video content available for browsing or viewing in one of a video on demand (“VoD”) platform, a video streaming platform, or a digital video recording (“DVR”) platform, and/or the like.

Merely by way of example, in some embodiments, automatically shifting from presentation of the first audio content to presentation of the second audio content using the audio shift using the audio playback device might comprise automatically shifting from presentation of the first audio content to presentation of the second audio content using one of a simple multiplication in digital domain, dithering volume control in digital domain, adjusting the gain of an amplification stage (e.g., via adjustment of suitable resistor values in an amplifier's negative feedback loop, or the like), or in the analog domain using analog switches and a stepped resistor network to implement the audio shift, and/or the like.

According to some embodiments, the apparatus might comprise one of a set-top box, a digital video recording (“DVR”) device, a display device running a software application (“app”), the audio playback device, a user device running an app, a media player, a gaming console, sound studio audio equipment, video editing equipment, broadcast equipment, a video head-end, audio equipment associated with a sound reinforcement installation, audio equipment associated with a public address system, a server computer over a network, or a cloud-based computing system over a network, and/or the like. In some embodiments, the audio playback device might comprise one or more speakers external to but communicatively coupled to a display device, one of one or more speakers of the display device, one or more speakers external to but communicatively coupled to the computing system, one or more speakers of the computing system, one or more speakers external to but communicatively coupled to a user device, one or more speakers of the user device, one or more headphones, one or more earbuds, one or more sound bars, one or more wireless speakers, or one or more stereo speakers, and/or the like.

In yet another aspect, a system might comprise a computing system and an audio playback device. The computing system might comprise at least one first processor and a first non-transitory computer readable medium communicatively coupled to the at least one first processor. The first non-transitory computer readable medium might have stored thereon computer software comprising a first set of instructions that, when executed by the at least one first processor, causes the computing system to: send a first audio content to an audio playback device.

The audio playback device might comprise one or more speakers, at least one second processor, and a second non-transitory computer readable medium communicatively coupled to the at least one second processor. The second non-transitory computer readable medium might have stored thereon computer software comprising a second set of instructions that, when executed by the at least one second processor, causes the audio playback device to: receive the first audio content from the computing system; and present the first audio content to a user using the one or more speakers.

The first set of instructions, when executed by the at least one first processor, might further cause the computing system to: receive user input from the user, the user input being indicative of a desire by the user to switch from presentation of the first audio content to presentation of a second audio content; and in response to receiving the user input, send command instructions to the audio playback device to automatically shift from presentation of the first audio content to presentation of the second audio content using an audio shift and send the second audio content to the audio playback device. The second set of instructions, when executed by the at least one first processor, might further cause the audio playback device to: receive the command instructions from the computing system; receive the second audio content from the computing system; and in response to receiving the command instructions, automatically shift from presentation of the first audio content to presentation of the second audio content using the audio shift using the one or more speakers, the audio shift comprising a gradual decrease in volume of the first audio content to mute followed by a gradual increase in volume of the second audio content from mute.

In some embodiments, the gradual decrease in volume of the first audio content and the corresponding gradual increase in volume of the second audio content might comprise one of a mirrored pair of linear ramp waveforms, a mirrored pair of S-curved waveforms, or a mirrored pair of non-S-curved waveforms, and/or the like. In some cases, the volume of the second audio content after the gradual increase in volume might match the volume of the first audio content prior to the gradual decrease in volume.

According to some embodiments, the system might further comprise a display device, comprising a display screen, at least one third processor, and a third non-transitory computer readable medium communicatively coupled to the at least one third processor. The third non-transitory computer readable medium might have stored thereon computer software comprising a third set of instructions that, when executed by the at least one third processor, causes the display device to: display a first video content to the user on a display device, the first audio content corresponding to the first video content, wherein the user input is further indicative of a desire by the user to switch from display of the first video content to display of a second video content on the display device, the second audio content corresponding to the second video content; and further in response to receiving the user input, automatically shift from display of the first video content to display of the second video content on the display device, concurrent with automatically shifting from presentation of the first audio content to presentation of the second audio content using the audio shift using the audio playback device.

In some cases, the automatic shifting from display of the first video content to display of the second video content on the display device might be initiated during the gradual decrease in volume of the first audio content and before the volume of the first audio content is fully muted. Alternatively, the automatic shifting from display of the first video content to display of the second video content on the display device might be initiated after the volume of the first audio content is fully muted, while the gradual increase in volume of the second audio content might be initiated after completion of the automatic shifting from display of the first video content to display of the second video content on the display device. In some cases, the display device might comprise one of a television set, a smart television, a computer monitor, or a laptop monitor, and/or the like. In some instances, each of the first video content and the second video content might comprise video content that is broadcast on a broadcast channel. Alternatively, each of the first video content and the second video content might comprise video content among a plurality of video content available for browsing or viewing in one of a video on demand (“VoD”) platform, a video streaming platform, or a digital video recording (“DVR”) platform, and/or the like.

Merely by way of example, in some embodiments, automatically shifting from presentation of the first audio content to presentation of the second audio content using the audio shift using the audio playback device might comprise automatically shifting, with the computing system, from presentation of the first audio content to presentation of the second audio content using one of a simple multiplication in digital domain, dithering volume control in digital domain, adjusting the gain of an amplification stage (e.g., via adjustment of suitable resistor values in an amplifier's negative feedback loop, or the like), or in the analog domain using analog switches and a stepped resistor network to implement the audio shift, and/or the like.

According to some embodiments, the computing system might comprise one of a set-top box, a digital video recording (“DVR”) device, a display device running a software application (“app”), the audio playback device, a user device running an app, a media player, a gaming console, sound studio audio equipment, video editing equipment, broadcast equipment, a video head-end, audio equipment associated with a sound reinforcement installation, audio equipment associated with a public address system, a server computer over a network, or a cloud-based computing system over a network, and/or the like. In some embodiments, the audio playback device might comprise one or more speakers external to but communicatively coupled to a display device, one of one or more speakers of the display device, one or more speakers external to but communicatively coupled to the computing system, one or more speakers of the computing system, one or more speakers external to but communicatively coupled to a user device, one or more speakers of the user device, one or more headphones, one or more earbuds, one or more sound bars, one or more wireless speakers, or one or more stereo speakers, and/or the like.

Various modifications and additions can be made to the embodiments discussed without departing from the scope of the invention. For example, while the embodiments described above refer to particular features, the scope of this invention also includes embodiments having different combination of features and embodiments that do not include all of the above described features.

### Specific Exemplary Embodiments

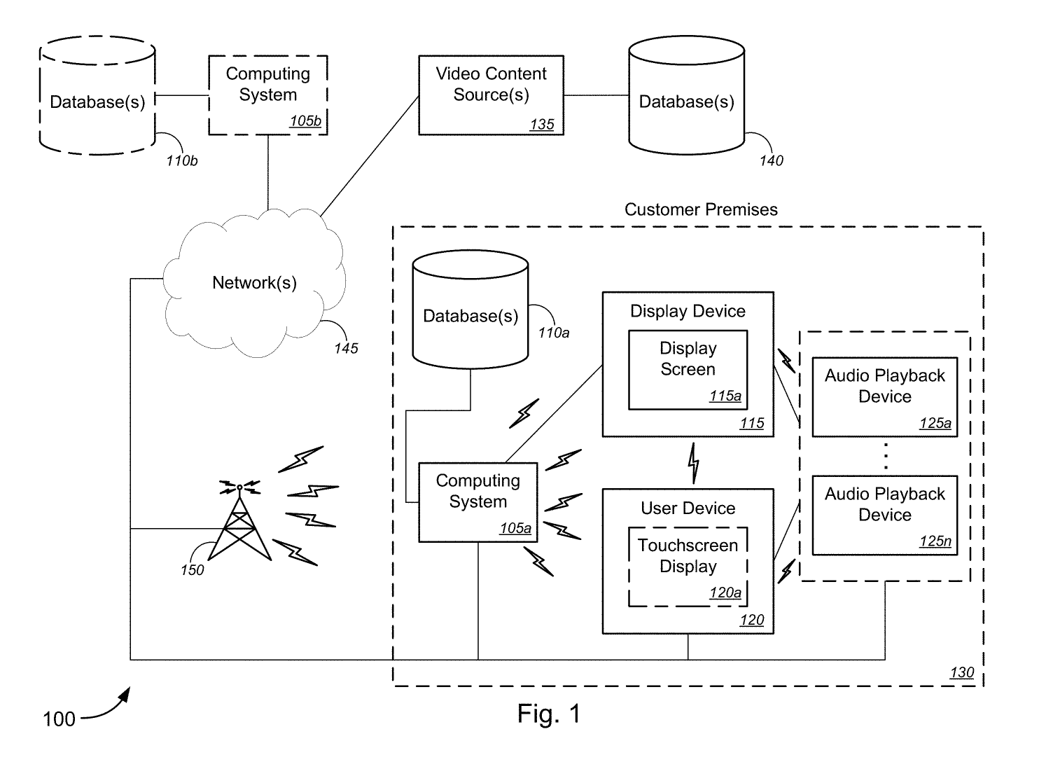

We now turn to the embodiments as illustrated by the drawings. FIGS. 1-8 illustrate some of the features of the method, system, and apparatus for implementing media content streaming or playback, and, more particularly, to methods, systems, and apparatuses for implementing advanced audio shifting, as referred to above. The methods, systems, and apparatuses illustrated by FIGS. 1-8 refer to examples of different embodiments that include various components and steps, which can be considered alternatives or which can be used in conjunction with one another in the various embodiments. The description of the illustrated methods, systems, and apparatuses shown in FIGS. 1-8 is provided for purposes of illustration and should not be considered to limit the scope of the different embodiments.

With reference to the figures, FIG. 1 is a schematic diagram illustrating a system 100 for implementing advanced audio shifting, in accordance with various embodiments.

In the non-limiting embodiment of FIG. 1, system 100 might comprise a computing system 105a and a data store or database 110a that is local to the computing system 105a. In some cases, the database 110a might be external, yet communicatively coupled, to the computing system 105a. In other cases, the database 110a might be integrated within the computing system 105a. System 100, according to some embodiments, might further comprise one or more display devices 115 (collectively, “display devices 115” or the like), which might each include a display screen 115a, and one or more user devices 120 (collectively, “user devices 120” or the like), which might each include a user input device, which in some cases might comprise a touchscreen display or touchscreen display device 120a (optional), and/or the like. In some cases, system 100 might further comprise one or more audio playback devices 125a-125n (collectively, “audio playback devices 125” or “speakers 125” or the like), and/or the like. Each of the computing system 105a, the one or more display devices 115, and/or the one or more user devices 120 might communicatively couple to the computing system 105a, and/or to each other, either via wireless connection and/or via wired connection.

The one or more user devices 120 might each receive user input from a user (in various embodiments, receiving touch input from the user via the optional touchscreen display 120a or via other user input device of the user device 120), and might each relay the user input to the computing system 105a, according to some embodiments. In some cases, the user devices 120 might include, without limitation, at least one of a dedicated remote control device (with or without touchscreen display) that is associated with the computing system 105a, a universal remote control device (with or without touchscreen display) that has been paired, synced, or synchronized with the computing system 105a, a tablet computer that has been paired, synced, or synchronized with the computing system 105a, a smart phone that has been paired, synced, or synchronized with the computing system 105a, or other portable device (with or without touchscreen display) that has been paired, synced, or synchronized with the computing system 105a, and/or the like. In some cases, the computing system 105a, the database 110a, the one or more display devices 115 (including the display screen(s) 115a and/or the audio playback device(s) 125, etc.), and the user device(s) 120 may be disposed within a customer premises 130, which might be one of a single family house, a multi-dwelling unit (“MDU”) within a multi-dwelling complex (including, but not limited to, an apartment building, an apartment complex, a condominium complex, a townhouse complex, a mixed-use building, etc.), a motel, an inn, a hotel, an office building or complex, a commercial building or complex, an industrial building or complex, and/or the like.

In some embodiments, the computing system 105a might comprise one of a processor within the display device running a software application (“app”), a processor within the user device running an app, a processor within one of the audio playback devices, a processor within a media device, a processor within audio and/or video processing equipment, and/or the like. In some cases, the media device might include, but is not limited to, one of a set-top box (“STB”), a media player, a gaming console, a server computer, a desktop computer, or a laptop computer, and/or the like. The media player might include, without limitation, one of a digital versatile disc or digital video disc (“DVD”) player, a Blu-ray disc (“BD”) player, a digital video recording (“DVR”) device, a streaming video player, a streaming music player, or a streaming game player, or any other media player capable of decoding and playing back content obtained via rotating media, solid state media, or streaming information from an external source, and/or the like, while the one or more display devices 115 might include, but are not limited to, at least one of one or more monitors (e.g., computer monitor or laptop monitor, or the like), one or more television sets (e.g., smart television sets or other television sets, or the like), and/or the like. In some cases, the user device 120 might include, without limitation, one of a laptop computer, a tablet computer, a smart phone, a mobile phone, a personal digital assistant, a remote control device, or a portable gaming device, and/or the like. The audio and/or video processing equipment, according to some embodiments, might include, but is not limited to, sound studio audio equipment, video editing equipment, broadcast equipment, a video head-end, audio equipment associated with a sound reinforcement installation, audio equipment associated with a public address system, and/or the like. In some embodiments, the audio playback devices 125 might each include, without limitation, one or more speakers external to but communicatively coupled to the display device 115 (e.g., a television, a monitor, or the like), one of one or more speakers of or integrated within the display device 115 (e.g., a television, a monitor, or the like), one or more speakers external to but communicatively coupled to the computing system 105a (e.g., a media device, a media player, or the like), one or more speakers of or integrated within the computing system 105a (e.g., a media device, a media player, or the like), one or more speakers external to but communicatively coupled to the user device 120 (e.g., a laptop computer, a tablet computer, a smart phone, a mobile phone, a personal digital assistant, a remote control device, or a portable gaming device, or the like), one or more speakers of or integrated within the user device 120 (e.g., a laptop computer, a tablet computer, a smart phone, a mobile phone, a personal digital assistant, a remote control device, or a portable gaming device, or the like), one or more headphones, one or more earbuds, one or more sound bars, one or more wireless speakers, or one or more stereo speakers, and/or the like.

System 100 might further comprise one or more media content sources or servers 135 and corresponding databases 140 that might communicatively couple to the computing system 105a via one or more networks 145 (and in some cases, via one or more telecommunications relay systems 150, which might include, without limitation, one or more wireless network interfaces (e.g., wireless modems, wireless access points, and the like), one or more towers, one or more satellites, and/or the like). The lightning bolt symbols are used to denote wireless communications between the one or more telecommunications relay systems 150 and the computing system 105a, between the one or more telecommunications relay systems 150 and each of at least one of the display devices 115, between the one or more telecommunications relay systems 150 and each of at least one of the user devices 120, between the computing system 105a and each of at least one of the display devices 115, between the computing system 105a and each of at least one of the user devices 120, between the display device 115 and the user devices 120, between the computing system 105a and each of the one or more audio playback devices 125a-125n, between the display device 115 and each of at least one of the one or more audio playback devices 125a-125n, between the user devices 120 and each of at least one of the one or more audio playback devices 125a-125n, and/or the like. According to some embodiments, alternative or additional to the computing system 105a and corresponding database 110a being disposed within customer premises 130, system 100 might comprise remote computing system 105b and corresponding database(s) 110b that communicatively couple with the one or more display devices 115, with the one or more user devices 120, and/or with the one or more audio playback devices 125a-125n in the customer premises 130 via the one or more networks 145 (and in some cases, via the one or more telecommunications relay systems 150). According to some embodiments, remote computing system 105b might comprise at least one of a server computer over a network, a cloud-based computing system over a network, and/or the like.

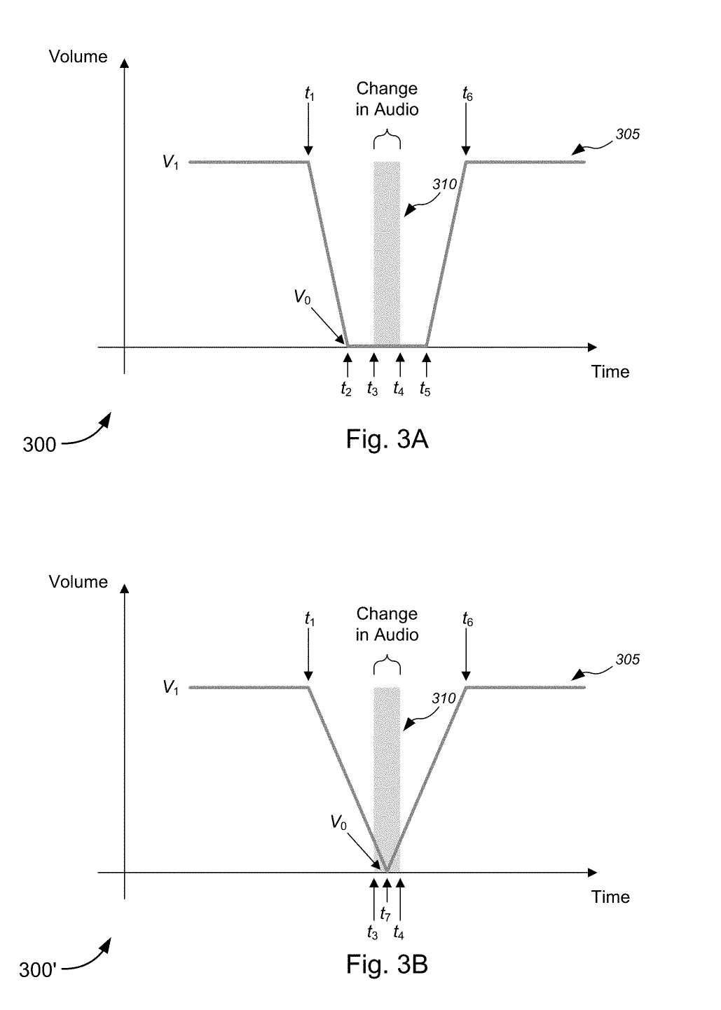

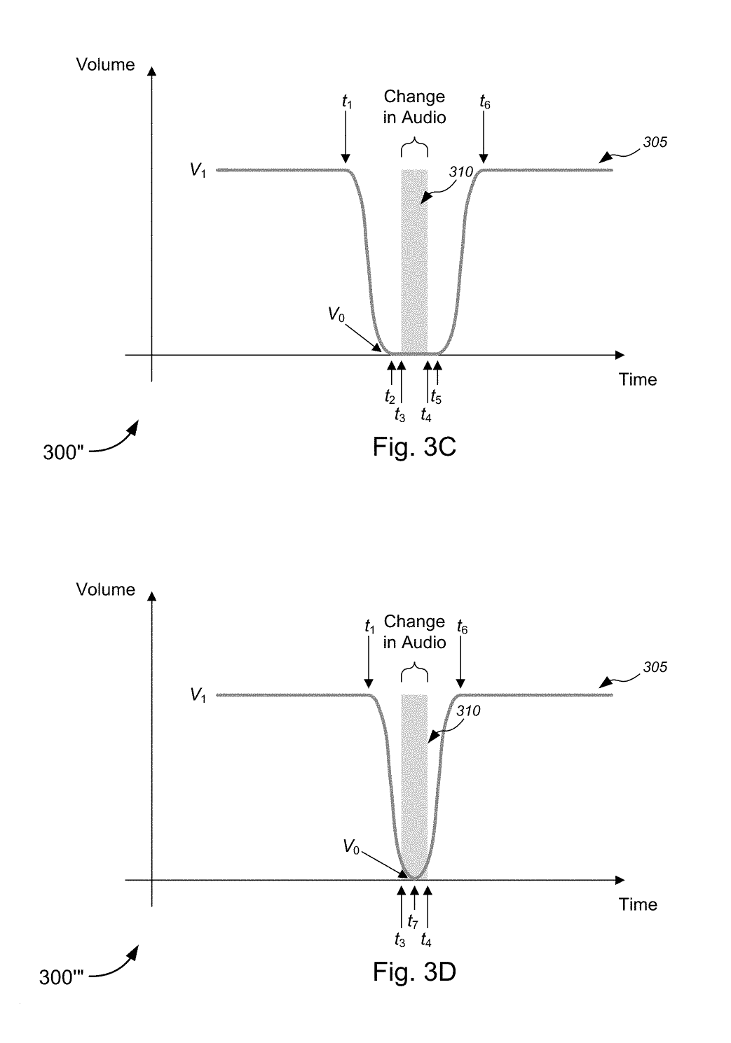

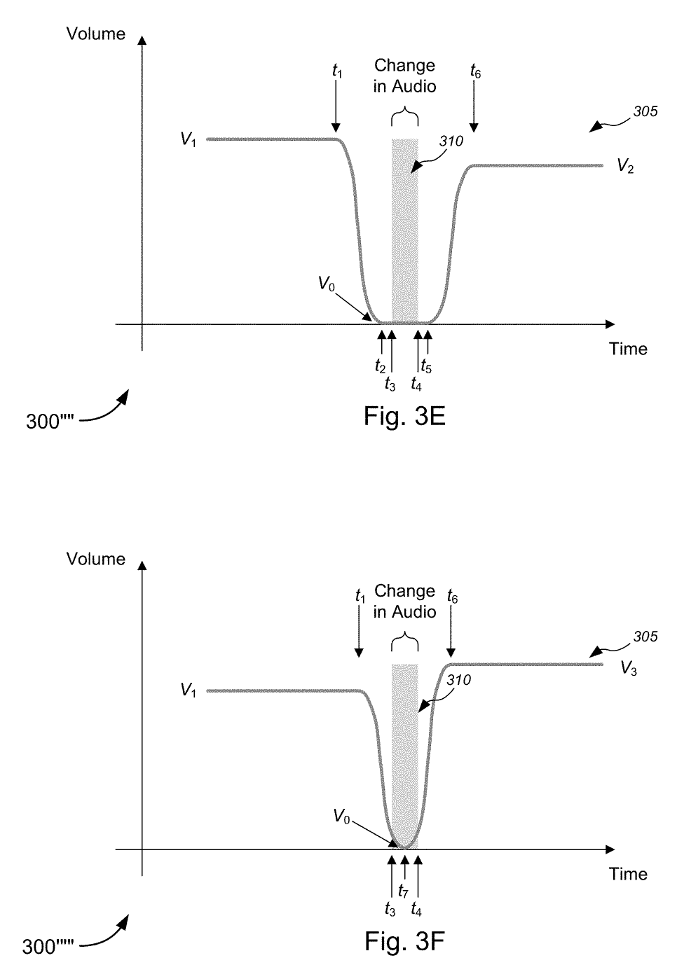

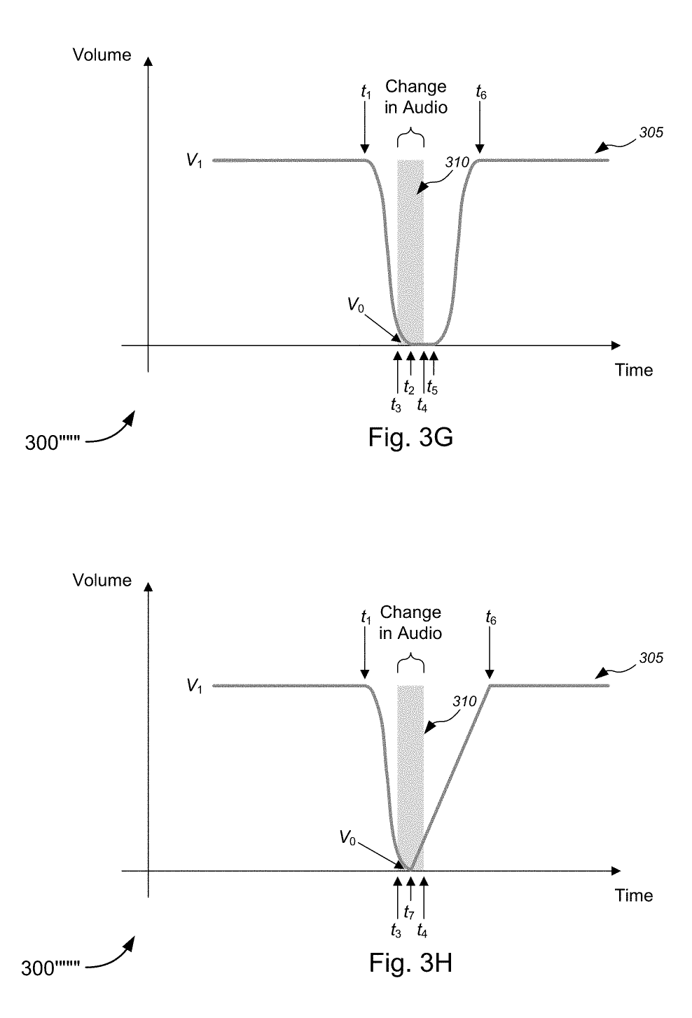

In operation, one of computing system 105a or 105b, display device 115, user device 120, or at least one audio playback device 125 might present a first audio content to a user using the at least one audio playback device 125. At least one of computing system 105a or 105b, display device 115, user device 120, or at least one audio playback device 125 might receive user input from the user, the user input being indicative of a desire by the user to switch from presentation of the first audio content to presentation of a second audio content. In response to receiving the user input, the at least one of computing system 105a or 105b, display device 115, user device 120, or at least one audio playback device 125 might automatically shift from presentation of the first audio content to presentation of the second audio content using an audio shift using the at least one audio playback device 125, the audio shift comprising a gradual decrease in volume of the first audio content to mute followed by a gradual increase in volume of the second audio content from mute (as shown and described below with respect to FIGS. 3A-3H, or the like). In some embodiments, the gradual decrease in volume of the first audio content and the corresponding gradual increase in volume of the second audio content might comprise one of a mirrored pair of linear ramp waveforms, a mirrored pair of non-linear waveforms (e.g., S-curved waveforms, non-S-curved waveforms, or the like), and/or the like. In some cases, the volume of the second audio content after the gradual increase in volume might match the volume of the first audio content prior to the gradual decrease in volume. Alternatively, the volume of the second audio content after the gradual increase in volume might differ from the volume of the first audio content prior to the gradual decrease in volume.

According to some embodiments (as shown and described below with respect to FIGS. 3A and 3C, or the like), the automatic shifting from presentation of the first audio content to presentation of the second audio content on the at least one audio playback device might be initiated after the volume of the first audio content is fully muted, while the gradual increase in volume of the second audio content might be initiated after completion of the automatic shifting from presentation of the first audio content to presentation of the second audio content on the at least one audio playback device. Alternatively, as shown and described below with respect to FIGS. 3B and 3D, or the like, the automatic shifting from presentation of the first audio content to presentation of the second audio content on the at least one audio playback device might be initiated during the gradual decrease in volume of the first audio content and before the volume of the first audio content is fully muted, and the increase in volume of the second audio content might be initiated before the automatic shifting from presentation of the first audio content to presentation of the second audio content on the at least one audio playback device has been completed.

In some aspects, the one of computing system 105a or 105b, display device 115, user device 120, or at least one audio playback device 125 might provide users with options to select the time constant (i.e., the ramp-down times and the ramp-up times, the decrease volume times and the increase volume times, etc.) for decreasing and increasing the volume, according to user or personal preferences. In some cases, the system might also provide the user with options to completely turn the audio shifting feature off, if the user prefers not to use it. In some embodiments, the system might implement an auto-adjustable fading technique or mechanism, where the time constants for ramp-down (or volume decrease) and for ramp-up (or volume increase) might depend on the channel or content changing time, which can be variable in some systems.

Merely by way of example, in some embodiments, automatically shifting from presentation of the first audio content to presentation of the second audio content using the audio shift using the audio playback device might include, without limitation, automatically shifting from presentation of the first audio content to presentation of the second audio content using one of a simple multiplication in digital domain, dithering volume control in digital domain, adjusting the gain of an amplification stage (e.g., via adjustment of suitable resistor values in an amplifier's negative feedback loop, or the like), or in the analog domain using analog switches and a stepped resistor network to implement the audio shift, and/or the like.

For embodiments in which audio shifting is implemented concurrently with video shifting (e.g., channel changing, switching between input streams in video streaming applications, switching between video content in DVR or other video recording/playback applications, and/or the like), one of computing system 105a or 105b, display device 115, user device 120, or at least one audio playback device 125 might display a first video content to the user on the display device 115 while concurrently presenting (in a time/frame-matched manner) a first audio content corresponding to the first video content to the user using the at least one audio playback device 125. At least one of computing system 105a or 105b, display device 115, user device 120, or at least one audio playback device 125 might receive user input from the user, the user input being indicative of a desire by the user to switch from display of the first video content to display of a second video content on the display device (and further indicative of a desire by the user to switch from presentation of the first audio content to presentation of a second audio content, which corresponds to the second video content).

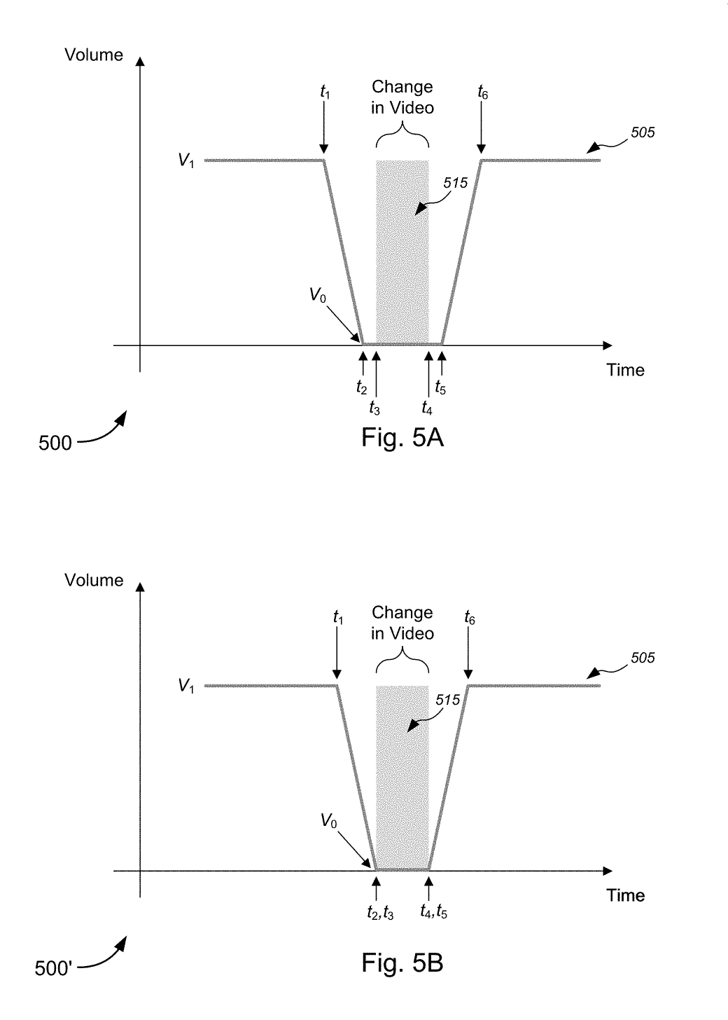

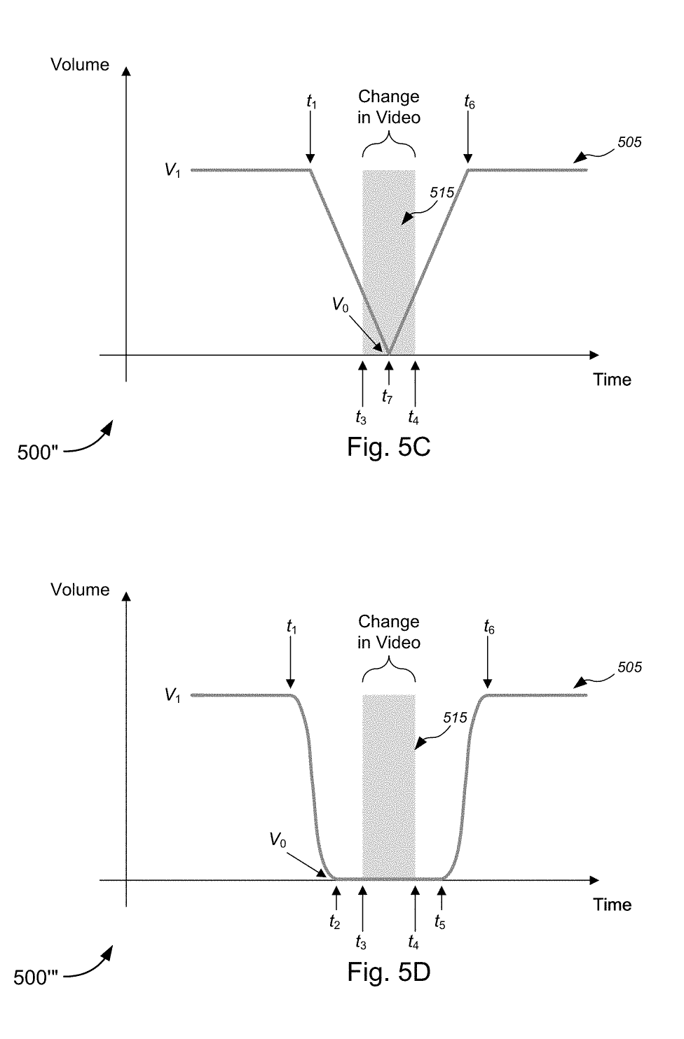

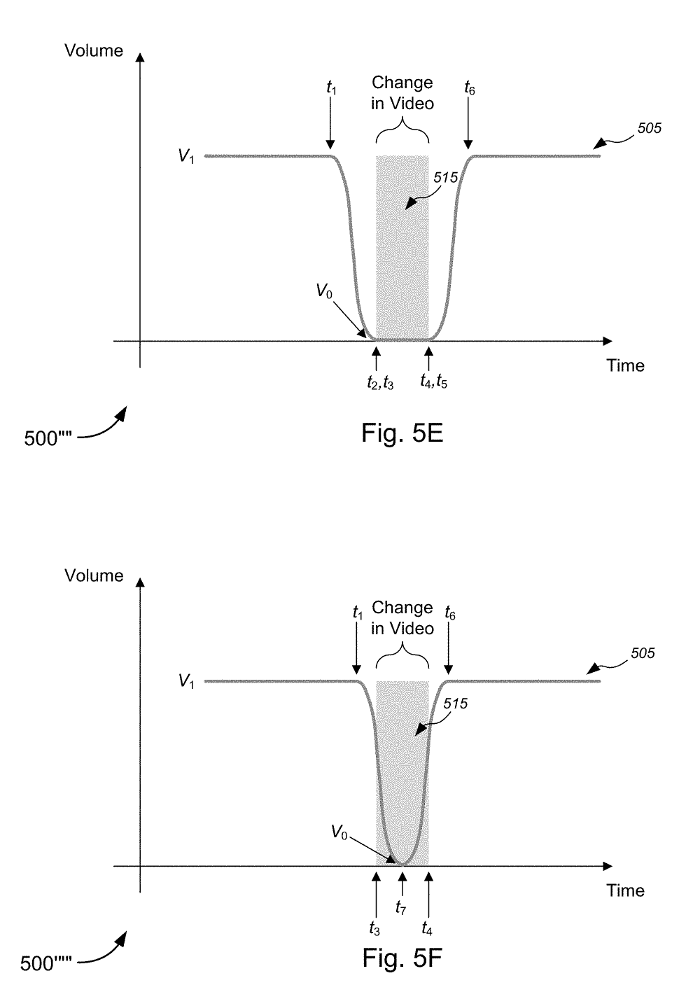

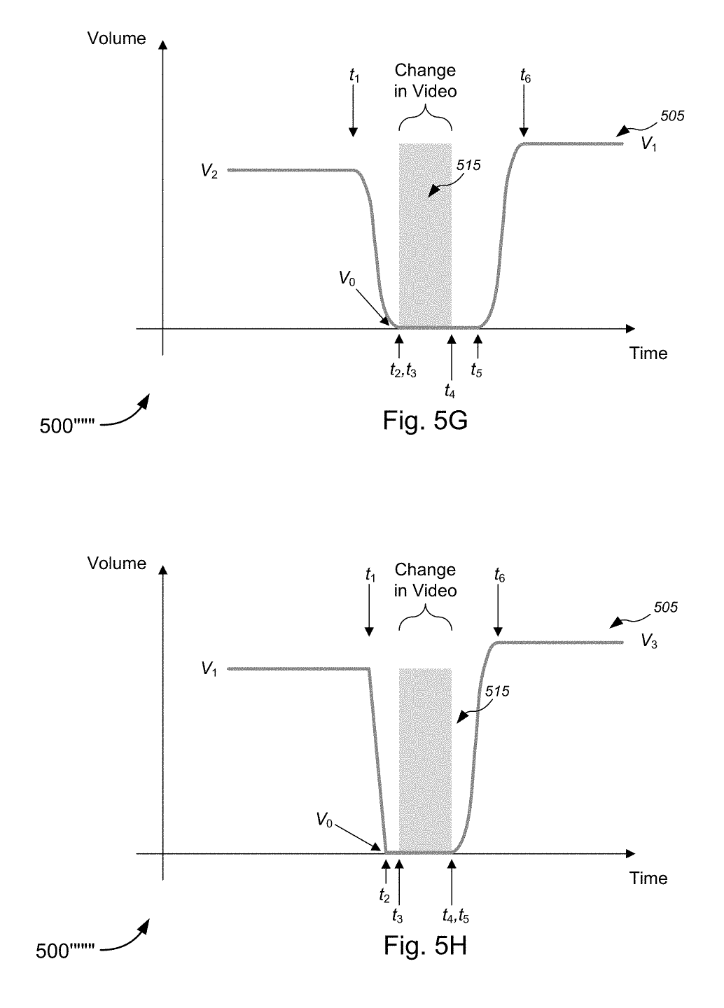

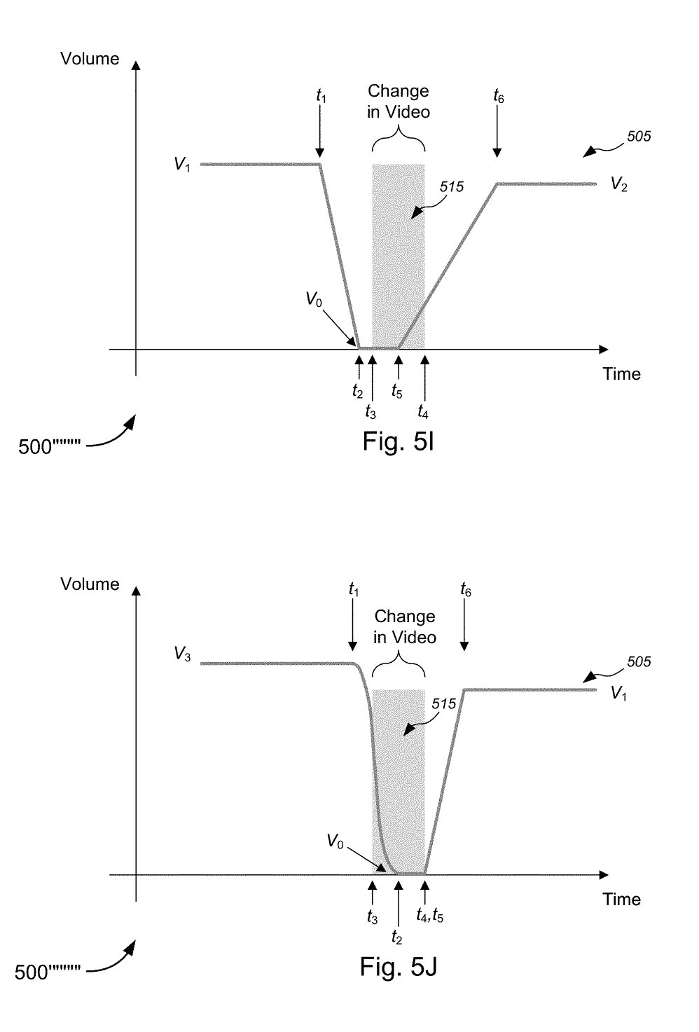

In response to receiving the user input, the at least one of computing system 105a or 105b, display device 115, user device 120, or at least one audio playback device 125 might automatically shift from presentation of the first audio content to presentation of the second audio content using an audio shift using the at least one audio playback device 125, the audio shift comprising a gradual decrease in volume of the first audio content to mute followed by a gradual increase in volume of the second audio content from mute (as shown and described below with respect to FIGS. 5A-5J, or the like). Some embodiments may approximate the gradual audio shift via a number of suitably small discrete steps in volume level change. In some embodiments, the gradual decrease in volume of the first audio content and the corresponding gradual increase in volume of the second audio content might comprise one of a mirrored pair of linear ramp waveforms, a mirrored pair of non-linear waveforms (e.g., S-curved waveforms, non-S-curved waveforms, or the like), and/or the like. In some cases, the volume of the second audio content after the gradual increase in volume might match the volume of the first audio content prior to the gradual decrease in volume. Alternatively, the volume of the second audio content after the gradual increase in volume might differ from the volume of the first audio content prior to the gradual decrease in volume. Further in response to receiving the user input, the at least one of computing system 105a or 105b, display device 115, user device 120, or at least one audio playback device 125 might automatically shift from display of the first video content to display of the second video content on the display device, concurrent with automatically shifting from presentation of the first audio content to presentation of the second audio content using the audio shift using the audio playback device.

According to some embodiments (as shown and described below with respect to FIGS. 5A, 5B, 5D, and 5E, or the like), the automatic shifting from display of the first video content to display of the second video content on the display device might be initiated after the volume of the first audio content is fully muted, while the gradual increase in volume of the second audio content might be initiated after completion of the automatic shifting from display of the first video content to display of the second video content on the display device. Alternatively, as shown and described below with respect to FIGS. 5C and 5F, or the like, the automatic shifting from display of the first video content to display of the second video content on the display device might be initiated during the gradual decrease in volume of the first audio content and before the volume of the first audio content is fully muted, and the increase in volume of the second audio content might be initiated before the automatic shifting from display of the first video content to display of the second video content on the display device has been completed.

Merely by way of example, in some embodiments, automatically shifting from presentation of the first audio content to presentation of the second audio content using the audio shift using the audio playback device might include, without limitation, automatically shifting from presentation of the first audio content to presentation of the second audio content using one of a simple multiplication in digital domain, dithering volume control in digital domain, adjusting the gain of an amplification stage (e.g., via adjustment of suitable resistor values in an amplifier's negative feedback loop, or the like), or in the analog domain using analog switches and a stepped resistor network to implement the audio shift, and/or the like.

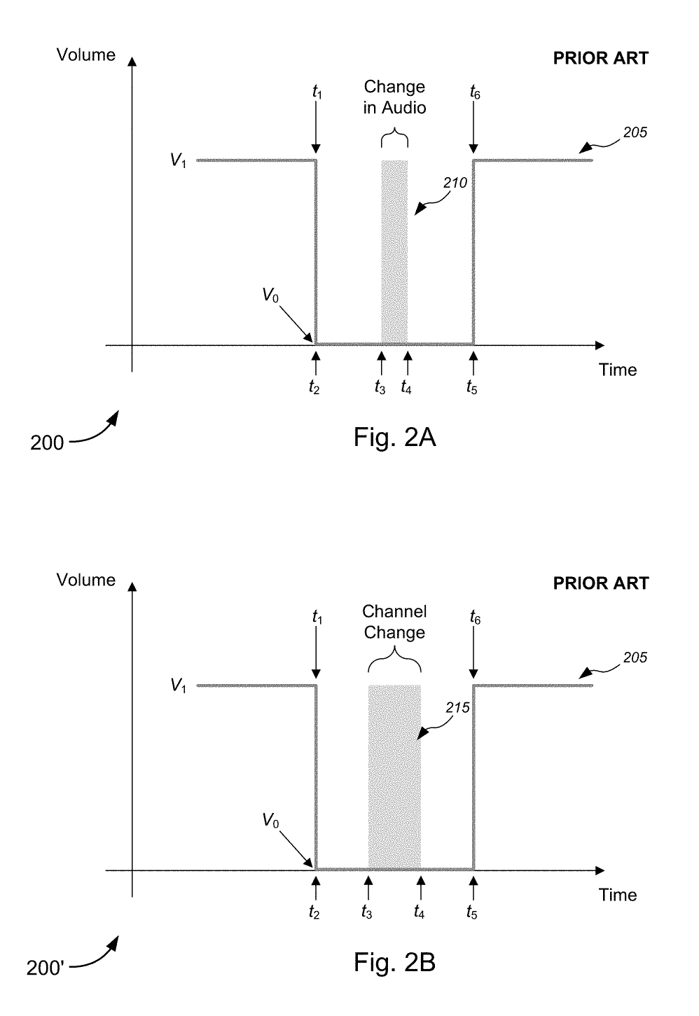

FIGS. 2A and 2B (collectively, “FIG. 2”) are graphical diagrams illustrating some examples 200 and 200′ of a conventional audio muting approach.

When changing channels on their conventional televisions (“TVs”) or selecting different inputs on their conventional media players or other conventional consumer electronics devices, users often hear noticeable popping, cracking, or crackling sounds. These sounds result from the sudden switch from one content source to another. These unwanted and often annoying sounds can be suppressed to some extent by simply muting the audio signal during the input or channel switching process. However, this conventional approach of completely turning the volume off and on during switching of audio sources (as shown in FIG. 2A) or during channel changes (as shown in FIG. 2B) does not completely address the inherent problem, and the switch from one audio source to another (whether for video content or for other media content with corresponding audio content) is still very sudden or abrupt, resulting in some popping, cracking, or crackling sounds.

With reference to FIG. 2A, example 200 depicts a volume control envelope 205 in the volume vs. time graph, with the bar 210 depicting the change in audio relative in time to the volume control envelope 205. For changes in audio (including, but not limited to, switching of inputs for audio-only content, switching of radio content, transitioning between two songs or musical pieces, and/or the like), a first audio content might be presented to the user, via one or more audio playback devices (such as audio playback devices 125 of FIG. 1, or the like), at a first volume (as shown in FIG. 2A as volume, V₁, in the volume vs. time graph). At time t₁, a user might provide user input indicating to change from presentation of the first audio content to presentation of a second audio content, or a system might receive the user input from the user. Immediately in response to receiving the user input (at time t₂, which is equal to or substantially equal to t₁), the conventional system might mute the volume of the first audio content (i.e., abruptly or suddenly reduce or decrease the volume of the first audio content to a volume that is equal to or substantially equal to zero volume, V₀). At time t₃, the conventional system might initiate the change in audio content (which as discussed above includes, but is not limited to, switching of inputs for audio-only content, switching of radio content, transitioning between two songs or musical pieces, and/or the like), which is completed by time t₄. The conventional system, at time t₅, might unmute the volume of the second audio content, which might effectively, at time t₆ (which is equal to or substantially equal to t₅), return to the volume level to a level that is similar or substantially the same as the volume V₁ (although the volume level might, in some cases, be set to a level that is different from volume V₁).

Similar to example 200 of FIG. 2A, example 200′ of FIG. 2B depicts a volume control envelope 205 in the volume vs. time graph, with the bar 215 depicting the change in channel (or other video shifting or the like) relative in time to the volume control envelope 205. For changes in audio content concurrent to video shifting (e.g., channel changing or changing streaming input, or the like), a first audio content corresponding to a first video content might be presented to the user concurrent with display of the first video content to the user on a display device (which might correspond to display devices 115 of FIG. 1, or the like), via one or more audio playback devices (such as audio playback devices 125 of FIG. 1, or the like), at a first volume (as shown in FIG. 2B as volume, V₁, in the volume vs. time graph). At time t₁, a user might provide user input indicating to change from display of the first video content to display of a second video content (which also indicates to change presentation of the first audio content corresponding to the first video content to presentation of a second audio content corresponding to the second video content), or a system might receive the user input from the user. Immediately in response to receiving the user input (at time t₂, which is equal to or substantially equal to t₁), the conventional system might mute the volume of the first audio content (i.e., abruptly or suddenly reduce or decrease the volume of the first audio content to a volume that is equal to or substantially equal to zero volume, V₀). At time t₃, the conventional system might initiate the change in video content (and also initiate the change in audio content), which is completed by time t₄. The conventional system, at time t₅, might unmute the volume of the second audio content, which might effectively, at time t₆ (which is equal to or substantially equal to t₅), return to the volume level to a level that is similar or substantially the same as the volume V₁ (although the volume level might, in some cases, be set to a level that is different from volume V₁).

As shown in FIG. 2, because the time t₁ (i.e., time that user input is received) and the time t₂ (i.e., time that volume of the first audio content has become muted) are the same (or substantially the same), the effect is an abrupt or sudden muting of first audio content. Similarly, because the time t₅ (i.e., time that volume of the second audio content has become unmuted) and the time t₆ (i.e., time that volume of the second audio content has been set to its presentation level (which in some cases, though not all cases, might be the same as volume level V₁) are the same (or substantially the same), the effect is an abrupt or sudden return to sound of the second audio content. Both of these abrupt or sudden muting or unmuting might result in the undesired popping, cracking, or crackling sounds, as discussed above.

FIGS. 3A-6 depict various embodiments that provide for gradual audio shifting, which results in reduction or elimination of the undesired popping, cracking, or crackling sounds that are caused by the abrupt of sudden volume jumps (either abrupt or sudden muting or abrupt or sudden unmuting).

FIGS. 3A-3H (collectively, “FIG. 3”) are graphical diagrams illustrating various embodiments 300, 300′, 300″, 300′″, 300″″, 300′″″, 300″″″ and 300′″″″ for implementing advanced audio shifting.

With reference to FIG. 3A, embodiment 300 depicts a volume control envelope 305 in the volume vs. time graph, with the bar 310 depicting the change in audio relative in time to the volume control envelope 305. For changes in audio (including, but not limited to, switching of inputs for audio-only content, switching of radio content, transitioning between two songs or musical pieces, and/or the like), a first audio content might be presented to the user, via one or more audio playback devices (such as audio playback devices 125 of FIG. 1, or the like), at a first volume (as shown in FIG. 3A as volume, V₁, in the volume vs. time graph). At time t₁, a user might provide user input indicating to change from presentation of the first audio content to presentation of a second audio content, or a system might receive the user input from the user. In response to receiving the user input, the system (which might correspond to computing system 105a or 105b, display device 115, user device 120, or audio playback device 125a-125n of FIG. 1, or the like) might gradually or gently initiate a decrease in the volume of the first audio content in a linear manner over time, such that the volume of the first audio content becomes mute (i.e., is equal to or substantially equal to zero volume, V₀) at time t₂, which is some time after time t₁. At time t₃ (which is some time after time t₂), the system might initiate the change in audio content (which as discussed above includes, but is not limited to, switching of inputs for audio-only content, switching of radio content, transitioning between two songs or musical pieces, and/or the like), which is completed by time t₄. The system, at time t₅ (which is some time after time t₄), might gradually or gently initiate an increase in the volume of the second audio content in a linear manner over time (which might mirror the linear decrease in volume of the first audio content), such that the volume of the second audio content goes from a muted level to return to a volume level that is similar or substantially the same as the volume V₁ (although the volume level might, in some cases, be set to a level that is different from volume V₁) by time t₆ (which is some time after time t₅). Such linear ramping of the volume control envelope 305 prior to and after the change in audio 310 significantly reduces or (in some cases) even eliminates the undesired popping, cracking, or crackling sounds that are caused by the abrupt of sudden volume jumps (either abrupt or sudden muting or abrupt or sudden unmuting) of the conventional muting approach as shown in the example 200 of FIG. 2A. In some cases (although not shown), the change in audio 310 might be initiated at the same time that the volume of the first audio content reaches volume V₀ (i.e., where time t₂ equals time t₃). Likewise, in some instances (although also not shown), the linear increase in volume of the second audio content might be initiated at the same time that the change in audio 310 is completed (i.e., where time t₄ equals time t₅).

Alternatively, referring to FIG. 3B, embodiment 300′ depicts a volume control envelope 305 in the volume vs. time graph, with the bar 310 depicting the change in audio relative in time to the volume control envelope 305. For changes in audio (including, but not limited to, switching of inputs for audio-only content, switching of radio content, transitioning between two songs or musical pieces, and/or the like), a first audio content might be presented to the user, via one or more audio playback devices (such as audio playback devices 125 of FIG. 1, or the like), at a first volume (as shown in FIG. 3B as volume, V₁, in the volume vs. time graph). At time t₁, a user might provide user input indicating to change from presentation of the first audio content to presentation of a second audio content, or a system might receive the user input from the user. In response to receiving the user input, the system (which might correspond to computing system 105a or 105b, display device 115, user device 120, or audio playback device 125a-125n of FIG. 1, or the like) might gradually or gently initiate a decrease in the volume of the first audio content in a linear manner over time, such that the volume of the first audio content becomes mute (i.e., is equal to or substantially equal to zero volume, V₀) at time t₇, which is some time after time t₁. At time t₃ (which is between times t₁ and t₇), the system might initiate the change in audio content (which as discussed above includes, but is not limited to, switching of inputs for audio-only content, switching of radio content, transitioning between two songs or musical pieces, and/or the like), which is completed by time t₄. The system, at time t₇ (which is before time t₄, at which the change in audio content is completed), might gradually or gently initiate an increase in the volume of the second audio content in a linear manner over time (which might mirror the linear decrease in volume of the first audio content), such that the volume of the second audio content goes from a muted level to return to a volume level that is similar or substantially the same as the volume V₁ (although the volume level might, in some cases, be set to a level that is different from volume V₁) by time t₆ (which is some time after time t₇). Such linear ramping of the volume control envelope 305 during the change in audio 310 significantly reduces or (in some cases) even eliminates the undesired popping, cracking, or crackling sounds that are caused by the abrupt of sudden volume jumps (either abrupt or sudden muting or abrupt or sudden unmuting) of the conventional muting approach as shown in the example 200 of FIG. 2A. Although the slope in the linear ramp of FIG. 3A is shown to be greater than the slope in the linear ramp of FIG. 3B, the various embodiments are not so limited, and the slope can be set to any suitable amount, by increasing the difference (i.e., Δt) between times t₁ and t₂ (and correspondingly the difference (i.e., Δt) between times t₅ and t₆) or by decreasing the difference (i.e., Δt) between times t₁ and t₂ (and correspondingly the difference (i.e., Δt) between times t₅ and t₆), as appropriate or as desired.

Turning to FIG. 3C, embodiment 300″ depicts a volume control envelope 305 in the volume vs. time graph, with the bar 310 depicting the change in audio relative in time to the volume control envelope 305. For changes in audio (including, but not limited to, switching of inputs for audio-only content, switching of radio content, transitioning between two songs or musical pieces, and/or the like), a first audio content might be presented to the user, via one or more audio playback devices (such as audio playback devices 125 of FIG. 1, or the like), at a first volume (as shown in FIG. 3C as volume, V₁, in the volume vs. time graph). At time t₁, a user might provide user input indicating to change from presentation of the first audio content to presentation of a second audio content, or a system might receive the user input from the user. In response to receiving the user input, the system (which might correspond to computing system 105a or 105b, display device 115, user device 120, or audio playback device 125a-125n of FIG. 1, or the like) might gradually or gently initiate a decrease in the volume of the first audio content in a non-linear manner (i.e., using an S-curve or non-S-curve equation, or the like) over time, such that the volume of the first audio content becomes mute (i.e., is equal to or substantially equal to zero volume, V₀) at time t₂, which is some time after time t₁. At time t₃ (which is some time after time t₂), the system might initiate the change in audio content (which as discussed above includes, but is not limited to, switching of inputs for audio-only content, switching of radio content, transitioning between two songs or musical pieces, and/or the like), which is completed by time t₄. The system, at time t₅ (which is some time after time t₄), might gradually or gently initiate an increase in the volume of the second audio content in a non-linear manner (i.e., using an S-curve or non-S-curve equation, or the like) over time (which might mirror the non-linear decrease in volume of the first audio content), such that the volume of the second audio content goes from a muted level to return to a volume level that is similar or substantially the same as the volume V₁ (although the volume level might, in some cases, be set to a level that is different from volume V₁) by time t₆ (which is some time after time t₅). Such non-linear ramping of the volume control envelope 305 prior to and after the change in audio 310 significantly reduces or (in some cases) even eliminates the undesired popping, cracking, or crackling sounds that are caused by the abrupt of sudden volume jumps (either abrupt or sudden muting or abrupt or sudden unmuting) of the conventional muting approach as shown in the example 200 of FIG. 2A. In some cases (although not shown), the change in audio 310 might be initiated at the same time that the volume of the first audio content reaches volume V₀ (i.e., where time t₂ equals time t₃). Likewise, in some instances (although also not shown), the linear increase in volume of the second audio content might be initiated at the same time that the change in audio 310 is completed (i.e., where time t₄ equals time t₅).

Alternatively, with reference to FIG. 3D, embodiment 300′″ depicts a volume control envelope 305 in the volume vs. time graph, with the bar 310 depicting the change in audio relative in time to the volume control envelope 305. For changes in audio (including, but not limited to, switching of inputs for audio-only content, switching of radio content, transitioning between two songs or musical pieces, and/or the like), a first audio content might be presented to the user, via one or more audio playback devices (such as audio playback devices 125 of FIG. 1, or the like), at a first volume (as shown in FIG. 3D as volume, V₁, in the volume vs. time graph). At time t₁, a user might provide user input indicating to change from presentation of the first audio content to presentation of a second audio content, or a system might receive the user input from the user. In response to receiving the user input, the system (which might correspond to computing system 105a or 105b, display device 115, user device 120, or audio playback device 125a-125n of FIG. 1, or the like) might gradually or gently initiate a decrease in the volume of the first audio content in a non-linear manner (i.e., using an S-curve or non-S-curve equation, or the like) over time, such that the volume of the first audio content becomes mute (i.e., is equal to or substantially equal to zero volume, V₀) at time t₇, which is some time after time t₁. At time t₃ (which is between times t₁ and t₇), the system might initiate the change in audio content (which as discussed above includes, but is not limited to, switching of inputs for audio-only content, switching of radio content, transitioning between two songs or musical pieces, and/or the like), which is completed by time t₄. The system, at time t₇ (which is before time t₄, at which the change in audio content is completed), might gradually or gently initiate an increase in the volume of the second audio content in a non-linear manner (i.e., using an S-curve or non-S-curve equation, or the like) over time (which might mirror the non-linear decrease in volume of the first audio content), such that the volume of the second audio content goes from a muted level to return to a volume level that is similar or substantially the same as the volume V₁ (although the volume level might, in some cases, be set to a level that is different from volume V₁) by time t₆ (which is some time after time t₇). Such non-linear ramping of the volume control envelope 305 during the change in audio 310 significantly reduces or (in some cases) even eliminates the undesired popping, cracking, or crackling sounds that are caused by the abrupt of sudden volume jumps (either abrupt or sudden muting or abrupt or sudden unmuting) of the conventional muting approach as shown in the example 200 of FIG. 2A. Similar to the embodiments 300 and 300′, the rate of non-linear decrease and increase in volume in embodiments 300″ and 300″ may be changed or set as, as appropriate or as desired, by increasing the difference (i.e., Δt) between times t₁ and t₇ (and correspondingly the difference (i.e., Δt) between times t₇ and t₆) or by decreasing the difference (i.e., Δt) between times t₁ and t₇ (and correspondingly the difference (i.e., Δt) between times t₇ and t₆).

FIGS. 3E-3H depict various embodiments in which the volume envelope 305 is asymmetric about the change in audio 310. For example, in FIG. 3E, embodiment 300″″ depicts a volume envelope 305 that is similar to volume envelope 305 in embodiment 300″ of FIG. 3C except that the volume of the second audio content is set to volume V₂ after the gradual increase in volume level of the second audio content from mute, where the volume V₂ is less than the volume V₁ at which the first audio content is set prior to the gradual decrease in volume of the first audio content starting at time Similarly, in FIG. 3F, embodiment 300′″″ depicts a volume envelope 305 that is similar to volume envelope 305 in embodiment 300′″ of FIG. 3D except that the volume of the second audio content is set to volume V₃ after the gradual increase in volume level of the second audio content from mute, where the volume V₃ is greater than the volume V₁ at which the first audio content is set prior to the gradual decrease in volume of the first audio content starting at time t₁.

Aside from volume level asymmetries, the asymmetries in the volume envelope 305 can also be in terms of the shape of the volume envelope 305 and/or the time constant or timing relative to the audio change, as shown in FIGS. 3G and 3H (for example). For instance, with reference to FIG. 3G, a first audio content might be presented to the user, via one or more audio playback devices (such as audio playback devices 125 of FIG. 1, or the like), at a first volume (as shown in FIG. 3G as volume, V₁, in the volume vs. time graph). At time t₁, a user might provide user input indicating to change from presentation of the first audio content to presentation of a second audio content, or a system might receive the user input from the user. In response to receiving the user input, the system (which might correspond to computing system 105a or 105b, display device 115, user device 120, or audio playback device 125a-125n of FIG. 1, or the like) might gradually or gently initiate a decrease in the volume of the first audio content in a non-linear manner (i.e., using an S-curve or non-S-curve equation, or the like) over time, such that the volume of the first audio content becomes mute (i.e., is equal to or substantially equal to zero volume, V₀) at time t₂, which is some time after time t₁. At time t₃ (which is between times t₁ and t₂), the system might initiate the change in audio content (which as discussed above includes, but is not limited to, switching of inputs for audio-only content, switching of radio content, transitioning between two songs or musical pieces, and/or the like), which is completed by time t₄. The system, at time t₅ (which is some time after time t₄), might gradually or gently initiate an increase in the volume of the second audio content in a non-linear manner (i.e., using an S-curve or non-S-curve equation, or the like) over time (which might mirror the non-linear decrease in volume of the first audio content), such that the volume of the second audio content goes from a muted level to return to a volume level that is similar or substantially the same as the volume V₁ (although the volume level might, in some cases, be set to a level that is different from volume V₁) by time t₆ (which is some time after time t₅). Embodiment 300″″″ might otherwise be similar to embodiments 300″ and 300′″ of FIGS. 3C and 3D, respectively.

In another non-limiting example, in embodiment 300′″″″ of FIG. 3H, a first audio content might be presented to the user, via one or more audio playback devices (such as audio playback devices 125 of FIG. 1, or the like), at a first volume (as shown in FIG. 3G as volume, V₁, in the volume vs. time graph). At time t₁, a user might provide user input indicating to change from presentation of the first audio content to presentation of a second audio content, or a system might receive the user input from the user. In response to receiving the user input, the system (which might correspond to computing system 105a or 105b, display device 115, user device 120, or audio playback device 125a-125n of FIG. 1, or the like) might gradually or gently initiate a decrease in the volume of the first audio content in a non-linear manner (i.e., using an S-curve or non-S-curve equation, or the like) over time, such that the volume of the first audio content becomes mute (i.e., is equal to or substantially equal to zero volume, V₀) at time t₇, which is some time after time t₁. At time t₃ (which is between times t₁ and t₇), the system might initiate the change in audio content (which as discussed above includes, but is not limited to, switching of inputs for audio-only content, switching of radio content, transitioning between two songs or musical pieces, and/or the like), which is completed by time t₄. The system, at time t₇ (which is before time t₄, at which the change in audio content is completed), might gradually or gently initiate an increase in the volume of the second audio content in a linear manner over time (which might mirror the linear decrease in volume of the first audio content), such that the volume of the second audio content goes from a muted level to return to a volume level that is similar or substantially the same as the volume V₁ (although the volume level might, in some cases, be set to a level that is different from volume V₁) by time t₆ (which is some time after time t₇). Embodiment 300′″″″ might otherwise be similar to embodiments 300′ and 300′″ of FIGS. 3B and 3D, respectively.

Although some embodiments of the asymmetries in the volume envelope 305 are shown in FIG. 3 with specific or particular characteristics, the various embodiments are not limited to these depicted volume envelopes 305, and any combination of shapes of the volume envelope 305, volume levels, time constants (i.e., ramp-down (or volume decrease) times, ramp-up (or volume increase) times, etc.), timing of initiation of ramp-down (or volume decrease) relative to audio change, timing of mute relative to audio change, duration of mute, timing of initiation of ramp-up (or volume increase), timing of setting of the volume of the second audio content, and/or the like may be combined in any manner as appropriate or as desired.

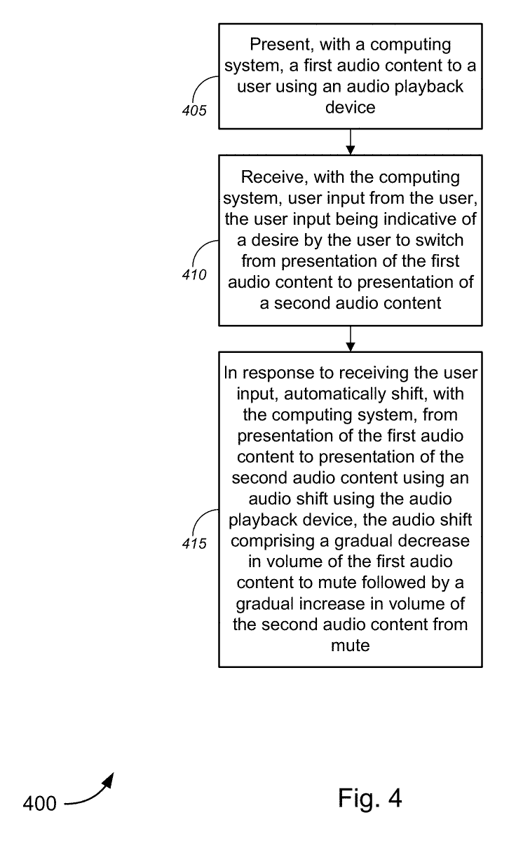

FIG. 4 is a flow diagram illustrating a method 400 for implementing advanced audio shifting, in accordance with various embodiments.

While the techniques and procedures are depicted and/or described in a certain order for purposes of illustration, it should be appreciated that certain procedures may be reordered and/or omitted within the scope of various embodiments. Moreover, while the method 400 illustrated by FIG. 4 can be implemented by or with (and, in some cases, are described below with respect to) the system 100 of FIG. 1 (or components thereof), such methods may also be implemented using any suitable hardware (or software) implementation. Similarly, while each of the system 100 of FIG. 1 (or components thereof), can operate according to the method 400 illustrated by FIG. 4 (e.g., by executing instructions embodied on a computer readable medium), the system 100 of FIG. 1 can each also operate according to other modes of operation and/or perform other suitable procedures.

In the non-limiting embodiment of FIG. 4, method 400, at block 405, presenting, with a computing system (which might correspond to computing systems 105a and 105b of FIG. 1, or the like), a first audio content to a user using an audio playback device (which might correspond to audio playback devices 125a-125n of FIG. 1, or the like). In some embodiments, the computing system might include, without limitation, one of a processor of a set-top box, a processor of a digital video recording (“DVR”) device, a processor of a display device running a software application (“app”), a processor of the audio playback device, a processor on a user device running an app, a processor of a media player, a processor of a gaming console, a processor in sound studio audio equipment, a processor in video editing equipment, a processor in broadcast equipment, a processor in a video head-end, a processor in audio equipment associated with a sound reinforcement installation, a processor in audio equipment associated with a public address system, a server computer over a network, or a cloud-based computing system over a network, and/or the like. According to some embodiments, the audio playback device might include, but is not limited to, one or more speakers external to but communicatively coupled to a television, one of one or more speakers of the television, one or more speakers external to but communicatively coupled to a media player, one or more speakers of the media player, one or more headphones, one or more earbuds, one or more sound bars, one or more wireless speakers, or one or more stereo speakers, and/or the like.

At block 410, method 400 might comprise receiving, with the computing system, user input from the user, the user input being indicative of a desire by the user to switch from presentation of the first audio content to presentation of a second audio content. In some cases, the user input might be received via a user device (which might correspond to user devices 120 of FIG. 1, or the like), which might include, without limitation, at least one of a dedicated remote control device that is associated with the computing system; a universal remote control device that has been paired, synced, or synchronized with the computing system; a tablet computer that has been paired, synced, or synchronized with the computing system; a smart phone that has been paired, synced, or synchronized with the computing system; or other portable device that has been paired, synced, or synchronized with the computing system; and/or the like.

Method 400 might further comprise, in response to receiving the user input, automatically shifting, with the computing system, from presentation of the first audio content to presentation of the second audio content using an audio shift using the audio playback device, the audio shift comprising a gradual decrease in volume of the first audio content to mute followed by a gradual increase in volume of the second audio content from mute (block 415). Some embodiments may approximate the gradual audio shift via a number of suitably small discrete steps in volume level change. In some embodiments, the gradual decrease in volume of the first audio content and the corresponding gradual increase in volume of the second audio content might comprise one of a mirrored pair of linear ramp waveforms, a mirrored pair of S-curved waveforms, or a mirrored pair of non-S-curved waveforms, and/or the like. Alternatively, or additionally, the volume of the second audio content after the gradual increase in volume might match the volume of the first audio content prior to the gradual decrease in volume. In other cases, the volume of the second audio content after the gradual increase in volume might differ from the volume of the first audio content prior to the gradual decrease in volume.

According to some embodiments, automatically shifting from presentation of the first audio content to presentation of the second audio content using the audio shift using the audio playback device might comprise automatically shifting, with the computing system, from presentation of the first audio content to presentation of the second audio content using one of a simple multiplication in digital domain, dithering volume control in digital domain, adjusting the gain of an amplification stage (e.g., via adjustment of suitable resistor values in an amplifier's negative feedback loop, or the like), or in the analog domain using analog switches and a stepped resistor network to implement the audio shift, and/or the like.

FIGS. 5A-5J (collectively, “FIG. 5”) are graphical diagrams illustrating various embodiments 500, 500′, 500″, 500′″, 500″″, 500′″″, 500″″″, 500′″″″, 500″″″″, and 500′″″″″ for implementing advanced audio shifting concurrent with video shifting.

With reference to FIG. 5A, embodiment 500 depicts a volume control envelope 505 in the volume vs. time graph, with the bar 515 depicting the change in channel (or other video shifting or the like) relative in time to the volume control envelope 505. For changes in audio content concurrent to video shifting (e.g., channel changing or changing streaming input, or the like), a first audio content corresponding to a first video content might be presented to the user concurrent with display of the first video content to the user on a display device (which might correspond to display devices 115 of FIG. 1, or the like), via one or more audio playback devices (such as audio playback devices 125 of FIG. 1, or the like), at a first volume (as shown in FIG. 5A as volume, V₁, in the volume vs. time graph). At time t₁, a user might provide user input indicating to change from display of the first video content to display of a second video content (which also indicates to change presentation of the first audio content corresponding to the first video content to presentation of a second audio content corresponding to the second video content), or a system might receive the user input from the user.

In response to receiving the user input, the system (which might correspond to computing system 105a or 105b, display device 115, user device 120, or audio playback device 125a-125n of FIG. 1, or the like) might gradually or gently initiate a decrease in the volume of the first audio content in a linear manner over time, such that the volume of the first audio content becomes mute (i.e., is equal to or substantially equal to zero volume, V₀) at time t₂, which is some time after time t₁. At time t₃ (which is some time after time t₂), the system might initiate the change in video content (and also initiate the change in audio content), which is completed by time t₄. The system, at time is (which is some time after time t₄), might gradually or gently initiate an increase in the volume of the second audio content in a linear manner over time (which might mirror the linear decrease in volume of the first audio content), such that the volume of the second audio content goes from a muted level to return to a volume level that is similar or substantially the same as the volume V₁ (although the volume level might, in some cases, be set to a level that is different from volume V₁) by time t₆ (which is some time after time t₅). Such linear ramping of the volume control envelope 505 prior to and after the video shifting 515 significantly reduces or (in some cases) even eliminates the undesired popping, cracking, or crackling sounds that are caused by the abrupt of sudden volume jumps (either abrupt or sudden muting or abrupt or sudden unmuting) of the conventional muting approach as shown in the example 200′ of FIG. 2B.

In some cases (as shown in embodiment 500′ of FIG. 5B), the change in audio 515 might be initiated at the same time that the volume of the first audio content reaches volume V₀ (i.e., where time t₂ equals time t₃). Likewise, in some instances (although also not shown), the linear increase in volume of the second audio content might be initiated at the same time that the change in audio 515 is completed (i.e., where time t₄ equals time t₅).

Alternatively, referring to FIG. 5C, embodiment 500″ depicts a volume control envelope 505 in the volume vs. time graph, with the bar 515 depicting the change in channel (or other video shifting or the like) relative in time to the volume control envelope 505. For changes in audio content concurrent to video shifting (e.g., channel changing or changing streaming input, or the like), a first audio content corresponding to a first video content might be presented to the user concurrent with display of the first video content to the user on a display device (which might correspond to display devices 115 of FIG. 1, or the like), via one or more audio playback devices (such as audio playback devices 125 of FIG. 1, or the like), at a first volume (as shown in FIG. 5C as volume, V₁, in the volume vs. time graph). At time t₁, a user might provide user input indicating to change from display of the first video content to display of a second video content (which also indicates to change presentation of the first audio content corresponding to the first video content to presentation of a second audio content corresponding to the second video content), or a system might receive the user input from the user.

In response to receiving the user input, the system (which might correspond to computing system 105a or 105b, display device 115, user device 120, or audio playback device 125a-125n of FIG. 1, or the like) might gradually or gently initiate a decrease in the volume of the first audio content in a linear manner over time, such that the volume of the first audio content becomes mute (i.e., is equal to or substantially equal to zero volume, V₀) at time t₇, which is some time after time t₁. At time t₃ (which is between times t₁ and t₇), the system might initiate the change in video content (and also initiate the change in audio content), which is completed by time t₄. The system, at time t₇ (which is before time t₄, at which the change in audio content is completed), might gradually or gently initiate an increase in the volume of the second audio content in a linear manner over time (which might mirror the linear decrease in volume of the first audio content), such that the volume of the second audio content goes from a muted level to return to a volume level that is similar or substantially the same as the volume V₁ (although the volume level might, in some cases, be set to a level that is different from volume V₁) by time t₆ (which is some time after time t₇). Such linear ramping of the volume control envelope 505 during the video shifting 515 significantly reduces or (in some cases) even eliminates the undesired popping, cracking, or crackling sounds that are caused by the abrupt of sudden volume jumps (either abrupt or sudden muting or abrupt or sudden unmuting) of the conventional muting approach as shown in the example 200′ of FIG. 2B. Although the slope in the linear ramp of FIGS. 5A and 5B is shown to be greater than the slope in the linear ramp of FIG. 5C, the various embodiments are not so limited, and the slope can be set to any suitable amount, by increasing the difference (i.e., Δt) between times t₁ and t₇ (and correspondingly the difference (i.e., Δt) between times t₇ and t₆) or by decreasing the difference (i.e., Δt) between times t₁ and t₇ (and correspondingly the difference (i.e., Δt) between times t₇ and t₆), as appropriate or as desired.

Turning to FIG. 5D, embodiment 500′″ depicts a volume control envelope 505 in the volume vs. time graph, with the bar 515 depicting the change in channel (or other video shifting or the like) relative in time to the volume control envelope 505. For changes in audio content concurrent to video shifting (e.g., channel changing or changing streaming input, or the like), a first audio content corresponding to a first video content might be presented to the user concurrent with display of the first video content to the user on a display device (which might correspond to display devices 115 of FIG. 1, or the like), via one or more audio playback devices (such as audio playback devices 125 of FIG. 1, or the like), at a first volume (as shown in FIG. 5D as volume, V₁, in the volume vs. time graph). At time t₁, a user might provide user input indicating to change from display of the first video content to display of a second video content (which also indicates to change presentation of the first audio content corresponding to the first video content to presentation of a second audio content corresponding to the second video content), or a system might receive the user input from the user.

In response to receiving the user input, the system (which might correspond to computing system 105a or 105b, display device 115, user device 120, or audio playback device 125a-125n of FIG. 1, or the like) might gradually or gently initiate a decrease in the volume of the first audio content in a non-linear manner (i.e., using an S-curve or non-S-curve equation, or the like) over time, such that the volume of the first audio content becomes mute (i.e., is equal to or substantially equal to zero volume, V₀) at time t₂, which is some time after time t₁. At time t₃ (which is some time after time t₂), the system might initiate the change in video content (and also initiate the change in audio content), which is completed by time t₄. The system, at time is (which is some time after time t₄), might gradually or gently initiate an increase in the volume of the second audio content in a non-linear manner (i.e., using an S-curve or non-S-curve equation, or the like) over time (which might mirror the non-linear decrease in volume of the first audio content), such that the volume of the second audio content goes from a muted level to return to a volume level that is similar or substantially the same as the volume V₁ (although the volume level might, in some cases, be set to a level that is different from volume V₁) by time t₆ (which is some time after time t₅). Such non-linear ramping of the volume control envelope 505 prior to and after the video shifting 515 significantly reduces or (in some cases) even eliminates the undesired popping, cracking, or crackling sounds that are caused by the abrupt of sudden volume jumps (either abrupt or sudden muting or abrupt or sudden unmuting) of the conventional muting approach as shown in the example 200′ of FIG. 2B.

In some cases (as shown in embodiment 500″″ of FIG. 5E), the change in audio 515 might be initiated at the same time that the volume of the first audio content reaches volume V₀ (i.e., where time t₂ equals time t₃). Likewise, in some instances (although also not shown), the non-linear increase in volume of the second audio content might be initiated at the same time that the change in audio 515 is completed (i.e., where time t₄ equals time t₅).

Alternatively, with reference to FIG. 5F, embodiment 500′″″ depicts a volume control envelope 505 in the volume vs. time graph, with the bar 515 depicting the change in channel (or other video shifting or the like) relative in time to the volume control envelope 505. For changes in audio content concurrent to video shifting (e.g., channel changing or changing streaming input, or the like), a first audio content corresponding to a first video content might be presented to the user concurrent with display of the first video content to the user on a display device (which might correspond to display devices 115 of FIG. 1, or the like), via one or more audio playback devices (such as audio playback devices 125 of FIG. 1, or the like), at a first volume (as shown in FIG. 5F as volume, V₁, in the volume vs. time graph). At time t₁, a user might provide user input indicating to change from display of the first video content to display of a second video content (which also indicates to change presentation of the first audio content corresponding to the first video content to presentation of a second audio content corresponding to the second video content), or a system might receive the user input from the user.

In response to receiving the user input, the system (which might correspond to computing system 105a or 105b, display device 115, user device 120, or audio playback device 125a-125n of FIG. 1, or the like) might gradually or gently initiate a decrease in the volume of the first audio content in a non-linear manner (i.e., using an S-curve or non-S-curve equation, or the like) over time, such that the volume of the first audio content becomes mute (i.e., is equal to or substantially equal to zero volume, V₀) at time t₇, which is some time after time t₁. At time t₃ (which is between times t₁ and t₇), the system might initiate the change in video content (and also initiate the change in audio content), which is completed by time t₄. The system, at time t₇ (which is before time t₄, at which the change in audio content is completed), might gradually or gently initiate an increase in the volume of the second audio content in a non-linear manner (i.e., using an S-curve or non-S-curve equation, or the like) over time (which might mirror the non-linear decrease in volume of the first audio content), such that the volume of the second audio content goes from a muted level to return to a volume level that is similar or substantially the same as the volume V₁ (although the volume level might, in some cases, be set to a level that is different from volume V₁) by time t₆ (which is some time after time t₇). Such non-linear ramping of the volume control envelope 505 during the video shifting 515 significantly reduces or (in some cases) even eliminates the undesired popping, cracking, or crackling sounds that are caused by the abrupt of sudden volume jumps (either abrupt or sudden muting or abrupt or sudden unmuting) of the conventional muting approach as shown in the example 200′ of FIG. 2B. Similar to the embodiments 500, 500′, and 500″, the rate of non-linear decrease and increase in volume in embodiments 500′″, 500″″, and 500′″″ may be changed or set as, as appropriate or as desired, by increasing the difference (i.e., Δt) between times t₁ and t₇ (and correspondingly the difference (i.e., Δt) between times t₇ and t₆) or by decreasing the difference (i.e., Δt) between times t₁ and t₇ (and correspondingly the difference (i.e., Δt) between times t₇ and t₆).

FIGS. 5G-5J depict various embodiments in which the volume envelope 505 is asymmetric about the change in video 515. For instance, in embodiment 500″″″ of FIG. 5G, a first audio content corresponding to a first video content might be presented to the user concurrent with display of the first video content to the user on a display device (which might correspond to display devices 115 of FIG. 1, or the like), via one or more audio playback devices (such as audio playback devices 125 of FIG. 1, or the like), at a second volume (as shown in FIG. 5G as volume, V₂ in the volume vs. time graph). At time t₁, a user might provide user input indicating to change from display of the first video content to display of a second video content (which also indicates to change presentation of the first audio content corresponding to the first video content to presentation of a second audio content corresponding to the second video content), or a system might receive the user input from the user.

In response to receiving the user input, the system (which might correspond to computing system 105a or 105b, display device 115, user device 120, or audio playback device 125a-125n of FIG. 1, or the like) might gradually or gently initiate a decrease in the volume of the first audio content in a non-linear manner (i.e., using an S-curve or non-S-curve equation, or the like) over time, such that the volume of the first audio content becomes mute (i.e., is equal to or substantially equal to zero volume, V₀) at time t₂, which is some time after time t₁. At time t₃ (which is equal to time t₂), the system might initiate the change in video content (and also initiate the change in audio content), which is completed by time t₄. The system, at time t₅ (which is some time after time t₄), might gradually or gently initiate an increase in the volume of the second audio content in a non-linear manner (i.e., using an S-curve or non-S-curve equation, or the like) over time, such that the volume of the second audio content goes from a muted level to return to a first volume V₁, which is greater than the second volume V₂ by time t₆ (which is some time after time t₅). Embodiment 500″″″ of FIG. 5G might otherwise be similar to embodiments 500′″ and 500″″ of FIGS. 5D and 5E, respectively.

In embodiment 500′ of FIG. 5H, a first audio content corresponding to a first video content might be presented to the user concurrent with display of the first video content to the user on a display device (which might correspond to display devices 115 of FIG. 1, or the like), via one or more audio playback devices (such as audio playback devices 125 of FIG. 1, or the like), at a first volume (as shown in FIG. 5H as volume, V₁, in the volume vs. time graph). At time t₁, a user might provide user input indicating to change from display of the first video content to display of a second video content (which also indicates to change presentation of the first audio content corresponding to the first video content to presentation of a second audio content corresponding to the second video content), or a system might receive the user input from the user.

In response to receiving the user input, the system (which might correspond to computing system 105a or 105b, display device 115, user device 120, or audio playback device 125a-125n of FIG. 1, or the like) might gradually or gently initiate a decrease in the volume of the first audio content in a linear manner over time, such that the volume of the first audio content becomes mute (i.e., is equal to or substantially equal to zero volume, V₀) at time t₂, which is some time after time t₁. At time t₃ (which is some time after time t₂), the system might initiate the change in video content (and also initiate the change in audio content), which is completed by time t₄. The system, at time t₅ (which is equal to time t₄), might gradually or gently initiate an increase in the volume of the second audio content in a non-linear manner (i.e., using an S-curve or non-S-curve equation, or the like) over time, such that the volume of the second audio content goes from a muted level to return to a third volume V₃, which is greater than the first volume V₁ by time t₆ (which is some time after time t₅). Embodiment 500′ of FIG. 5H might otherwise be similar to embodiments 500 and 500″″ of FIGS. 5A and 5E, respectively.

With reference to FIG. 5I, in embodiment 500″″″″, a first audio content corresponding to a first video content might be presented to the user concurrent with display of the first video content to the user on a display device (which might correspond to display devices 115 of FIG. 1, or the like), via one or more audio playback devices (such as audio playback devices 125 of FIG. 1, or the like), at a first volume (as shown in FIG. 5I as volume, V₁, in the volume vs. time graph). At time t₁, a user might provide user input indicating to change from display of the first video content to display of a second video content (which also indicates to change presentation of the first audio content corresponding to the first video content to presentation of a second audio content corresponding to the second video content), or a system might receive the user input from the user.

In response to receiving the user input, the system (which might correspond to computing system 105a or 105b, display device 115, user device 120, or audio playback device 125a-125n of FIG. 1, or the like) might gradually or gently initiate a decrease in the volume of the first audio content in a linear manner over time, such that the volume of the first audio content becomes mute (i.e., is equal to or substantially equal to zero volume, V₀) at time t₂, which is some time after time t₁. At time t₃ (which is some time after time t₂), the system might initiate the change in video content (and also initiate the change in audio content), which is completed by time t₄. The system, at time is (which is before time t₄, at which the change in audio content is completed), might gradually or gently initiate an increase in the volume of the second audio content in a linear manner over time, such that the volume of the second audio content goes from a muted level to a second volume V₂, which is lower than the first volume V₁ by time t₆ (which is some time after time t₇). Embodiment 500″″″″ of FIG. 5I might otherwise be similar to embodiments 500 and 500″ of FIGS. 5A and 5C, respectively.

In embodiment 500′″″″″ of FIG. 5J, a first audio content corresponding to a first video content might be presented to the user concurrent with display of the first video content to the user on a display device (which might correspond to display devices 115 of FIG. 1, or the like), via one or more audio playback devices (such as audio playback devices 125 of FIG. 1, or the like), at a third volume (as shown in FIG. 5J as volume, V₃, in the volume vs. time graph). At time t₁, a user might provide user input indicating to change from display of the first video content to display of a second video content (which also indicates to change presentation of the first audio content corresponding to the first video content to presentation of a second audio content corresponding to the second video content), or a system might receive the user input from the user.

In response to receiving the user input, the system (which might correspond to computing system 105a or 105b, display device 115, user device 120, or audio playback device 125a-125n of FIG. 1, or the like) might gradually or gently initiate a decrease in the volume of the first audio content in a non-linear manner (i.e., using an S-curve or non-S-curve equation, or the like) over time, such that the volume of the first audio content becomes mute (i.e., is equal to or substantially equal to zero volume, V₀) at time t₂, which is some time after time t₁. At time t₃ (which is between times t₁ and t₂), the system might initiate the change in video content (and also initiate the change in audio content), which is completed by time t₄. The system, at time is (which is equal to time t₄), might gradually or gently initiate an increase in the volume of the second audio content in a linear manner over time, such that the volume of the second audio content goes from a muted level to a first volume V₁ that is less than the third volume V₃ by time t₆ (which is some time after time t₅). Embodiment 500′″″″″ of FIG. 5J might otherwise be similar to embodiments 500′ and 500′″″ of FIGS. 5B and 5F, respectively.

Although some embodiments of the asymmetries in the volume envelope 505 are shown in FIG. 5 with specific or particular characteristics, the various embodiments are not limited to these depicted volume envelopes 505, and any combination of shapes of the volume envelope 505, volume levels, time constants (i.e., ramp-down (or volume decrease) times, ramp-up (or volume increase) times, etc.), timing of initiation of ramp-down (or volume decrease) relative to audio change, timing of mute relative to audio change, duration of mute, timing of initiation of ramp-up (or volume increase), timing of setting of the volume of the second audio content, and/or the like may be combined in any manner as appropriate or as desired.

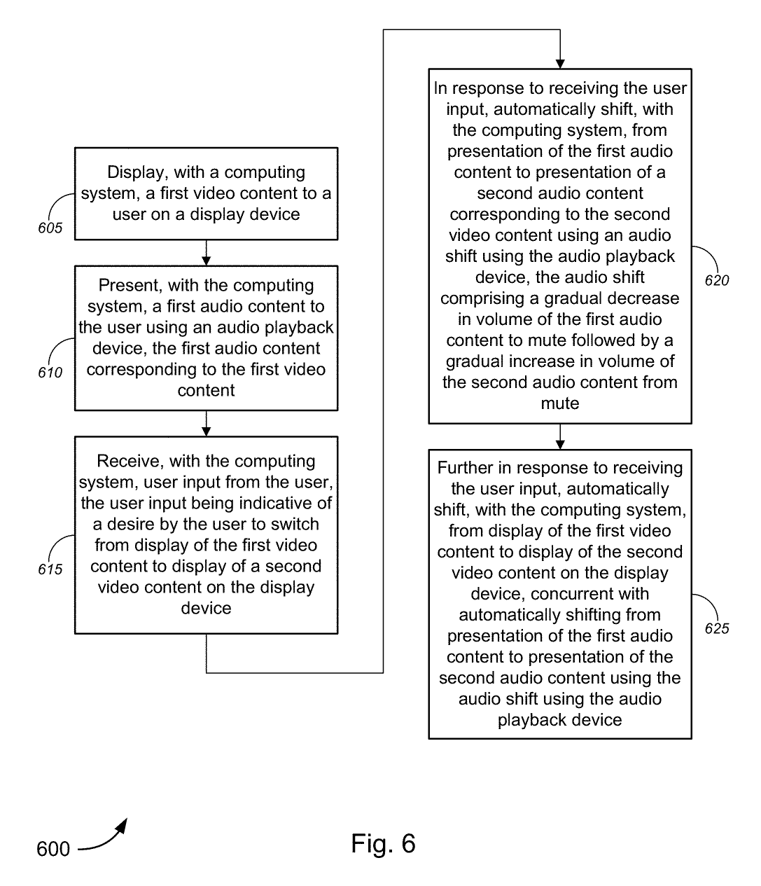

FIG. 6 is a flow diagram illustrating a method 600 for implementing advanced audio shifting concurrent with video shifting, in accordance with various embodiments.

While the techniques and procedures are depicted and/or described in a certain order for purposes of illustration, it should be appreciated that certain procedures may be reordered and/or omitted within the scope of various embodiments. Moreover, while the method 600 illustrated by FIG. 6 can be implemented by or with (and, in some cases, are described below with respect to) the system 100 of FIG. 1 (or components thereof), such methods may also be implemented using any suitable hardware (or software) implementation. Similarly, while each of the system 100 of FIG. 1 (or components thereof), can operate according to the method 600 illustrated by FIG. 6 (e.g., by executing instructions embodied on a computer readable medium), the system 100 of FIG. 1 can each also operate according to other modes of operation and/or perform other suitable procedures.

In the non-limiting embodiment of FIG. 6, method 600, at block 605, displaying, with a computing system (which might correspond to computing systems 105a and 105b of FIG. 1, or the like), a first video content to a user on a display device (which might correspond to display devices 115 of FIG. 1, or the like). In some embodiments, the computing system might include, without limitation, one of a processor of a set-top box, a processor of a digital video recording (“DVR”) device, a processor of a display device running a software application (“app”), a processor of the audio playback device, a processor on a user device running an app, a processor of a media player, a processor of a gaming console, a processor in sound studio audio equipment, a processor in video editing equipment, a processor in broadcast equipment, a processor in a video head-end, a processor in audio equipment associated with a sound reinforcement installation, a processor in audio equipment associated with a public address system, a server computer over a network, or a cloud-based computing system over a network, and/or the like. The display device, in some cases, might include, but is not limited to, at least one of one or more monitors (e.g., computer monitor or laptop monitor, or the like), one or more television sets (e.g., smart television sets or other television sets, or the like), and/or the like.

At block 610, method 600 might comprise presenting, with the computing system, a first audio content to the user using an audio playback device (which might correspond to audio playback devices 125a-125n of FIG. 1, or the like), the first audio content corresponding to the first video content, the first audio content being presented concurrent with (and matched with corresponding frames, scenes, or portions of) the first video content as it is being presented on the display device. According to some embodiments, the audio playback device might include, but is not limited to, one or more speakers external to but communicatively coupled to a television, one of one or more speakers of the television, one or more speakers external to but communicatively coupled to a media player, one or more speakers of the media player, one or more headphones, one or more earbuds, one or more sound bars, one or more wireless speakers, or one or more stereo speakers, and/or the like.

Method 600 might further comprise, at block 615, receiving, with the computing system, user input from the user, the user input being indicative of a desire by the user to switch from display of the first video content to display of a second video content on the display device. In some cases, the user input might be received via a user device (which might correspond to user devices 120 of FIG. 1, or the like), which might include, without limitation, at least one of a dedicated remote control device that is associated with the computing system; a universal remote control device that has been paired, synced, or synchronized with the computing system; a tablet computer that has been paired, synced, or synchronized with the computing system; a smart phone that has been paired, synced, or synchronized with the computing system; or other portable device that has been paired, synced, or synchronized with the computing system; and/or the like.

Method 600 might further comprise, in response to receiving the user input, automatically shifting, with the computing system, from presentation of the first audio content to presentation of a second audio content corresponding to the second video content, using an audio shift using the audio playback device, the audio shift comprising a gradual decrease in volume of the first audio content to mute followed by a gradual increase in volume of the second audio content from mute (block 620). Some embodiments may approximate the gradual audio shift via a number of suitably small discrete steps in volume level change. In some embodiments, the gradual decrease in volume of the first audio content and the corresponding gradual increase in volume of the second audio content might comprise one of a mirrored pair of linear ramp waveforms, a mirrored pair of S-curved waveforms, or a mirrored pair of non-S-curved waveforms, and/or the like. Alternatively, or additionally, the volume of the second audio content after the gradual increase in volume might match the volume of the first audio content prior to the gradual decrease in volume. In other cases, the volume of the second audio content after the gradual increase in volume might differ from the volume of the first audio content prior to the gradual decrease in volume.

According to some embodiments, automatically shifting from presentation of the first audio content to presentation of the second audio content using the audio shift using the audio playback device might comprise automatically shifting, with the computing system, from presentation of the first audio content to presentation of the second audio content using one of a simple multiplication in digital domain, dithering volume control in digital domain, adjusting the gain of an amplification stage (e.g., via adjustment of suitable resistor values in an amplifier's negative feedback loop, or the like), or in the analog domain using analog switches and a stepped resistor network to implement the audio shift, and/or the like.

At block 625, method 600 might comprise, further in response to receiving the user input, automatically shifting, with the computing system, from display of the first video content to display of the second video content on the display device, concurrent with automatically shifting from presentation of the first audio content to presentation of the second audio content using the audio shift using the audio playback device. In some cases, the automatic shifting from display of the first video content to display of the second video content on the display device might be initiated during the gradual decrease in volume of the first audio content and before the volume of the first audio content is fully muted (as shown and described above, e.g., in the embodiments of 500″ and 500′″″ of FIGS. 5C and 5F, respectively, or the like). Alternatively, the automatic shifting from display of the first video content to display of the second video content on the display device is initiated after the volume of the first audio content is fully muted, and where the gradual increase in volume of the second audio content is initiated after completion of the automatic shifting from display of the first video content to display of the second video content on the display device (as shown and described above, e.g., in the embodiments of 500, 500′, 500′″, and 500″″ of FIGS. 5A, 5B, 5D, and 5E, respectively, or the like).

In some embodiments, each of the first video content and the second video content might comprise video content that is broadcast on a broadcast channel. Alternatively, each of the first video content and the second video content might comprise video content among a plurality of video content available for browsing or viewing in one of a video on demand (“VoD”) platform, a video streaming platform, or a digital video recording (“DVR”) platform, and/or the like.

Exemplary System and Hardware Implementation

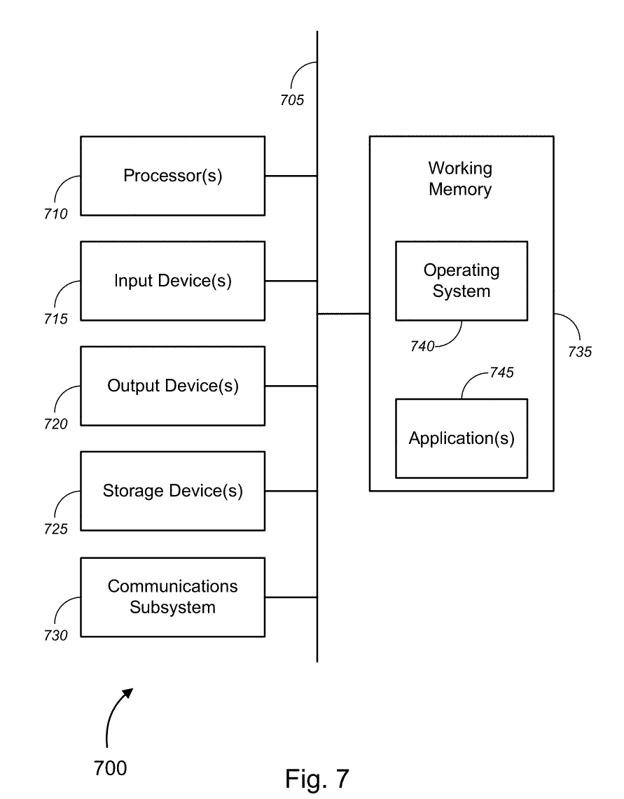

FIG. 7 is a block diagram illustrating an exemplary computer or system hardware architecture, in accordance with various embodiments. FIG. 7 provides a schematic illustration of one embodiment of a computer system 700 of the service provider system hardware that can perform the methods provided by various other embodiments, as described herein, and/or can perform the functions of computer or hardware system (i.e., computing systems 105a and 105b, display devices 115, user devices 120, audio playback devices 125a-125n, video content sources (or servers) 135, etc.), as described above. It should be noted that FIG. 7 is meant only to provide a generalized illustration of various components, of which one or more (or none) of each may be utilized as appropriate. FIG. 7, therefore, broadly illustrates how individual system elements may be implemented in a relatively separated or relatively more integrated manner.

The computer or hardware system 700—which might represent an embodiment of the computer or hardware system (i.e., computing systems 105a and 105b, display devices 115, user devices 120, audio playback devices 125a-125n, video content sources (or servers) 135, etc.), described above with respect to FIGS. 1-6—is shown comprising hardware elements that can be electrically coupled via a bus 705 (or may otherwise be in communication, as appropriate). The hardware elements may include one or more processors 710, including, without limitation, one or more general-purpose processors and/or one or more special-purpose processors (such as microprocessors, digital signal processing chips, graphics acceleration processors, and/or the like); one or more input devices 715, which can include, without limitation, a mouse, a keyboard and/or the like; and one or more output devices 720, which can include, without limitation, a display device, a printer, and/or the like.

The computer or hardware system 700 may further include (and/or be in communication with) one or more storage devices 725, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable and/or the like. Such storage devices may be configured to implement any appropriate data stores, including, without limitation, various file systems, database structures, and/or the like.

The computer or hardware system 700 might also include a communications subsystem 730, which can include, without limitation, a modem, a network card (wireless or wired), an infra-red communication device, a wireless communication device and/or chipset (such as a Bluetooth™ device, an 802.11 device, a WiFi device, a WiMax device, a WWAN device, cellular communication facilities, etc.), and/or the like. The communications subsystem 730 may permit data to be exchanged with a network (such as the network described below, to name one example), with other computer or hardware systems, and/or with any other devices described herein. In many embodiments, the computer or hardware system 700 will further comprise a working memory 735, which can include a RAM or ROM device, as described above.

The computer or hardware system 700 also may comprise software elements, shown as being currently located within the working memory 735, including an operating system 740, device drivers, executable libraries, and/or other code, such as one or more application programs 745, which may comprise computer programs provided by various embodiments (including, without limitation, hypervisors, VMs, and the like), and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 725 described above. In some cases, the storage medium might be incorporated within a computer system, such as the system 700. In other embodiments, the storage medium might be separate from a computer system (i.e., a removable medium, such as a compact disc, etc.), and/or provided in an installation package, such that the storage medium can be used to program, configure and/or adapt a general purpose computer with the instructions/code stored thereon. These instructions might take the form of executable code, which is executable by the computer or hardware system 700 and/or might take the form of source and/or installable code, which, upon compilation and/or installation on the computer or hardware system 700 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer or hardware system (such as the computer or hardware system 700) to perform methods in accordance with various embodiments of the invention. According to a set of embodiments, some or all of the procedures of such methods are performed by the computer or hardware system 700 in response to processor 710 executing one or more sequences of one or more instructions (which might be incorporated into the operating system 740 and/or other code, such as an application program 745) contained in the working memory 735. Such instructions may be read into the working memory 735 from another computer readable medium, such as one or more of the storage device(s) 725. Merely by way of example, execution of the sequences of instructions contained in the working memory 735 might cause the processor(s) 710 to perform one or more procedures of the methods described herein.

The terms “machine readable medium” and “computer readable medium,” as used herein, refer to any medium that participates in providing data that causes a machine to operate in a specific fashion. In an embodiment implemented using the computer or hardware system 700, various computer readable media might be involved in providing instructions/code to processor(s) 710 for execution and/or might be used to store and/or carry such instructions/code (e.g., as signals). In many implementations, a computer readable medium is a non-transitory, physical, and/or tangible storage medium. In some embodiments, a computer readable medium may take many forms, including, but not limited to, non-volatile media, volatile media, or the like. Non-volatile media includes, for example, optical and/or magnetic disks, such as the storage device(s) 725. Volatile media includes, without limitation, dynamic memory, such as the working memory 735. In some alternative embodiments, a computer readable medium may take the form of transmission media, which includes, without limitation, coaxial cables, copper wire and fiber optics, including the wires that comprise the bus 705, as well as the various components of the communication subsystem 730 (and/or the media by which the communications subsystem 730 provides communication with other devices). In an alternative set of embodiments, transmission media can also take the form of waves (including without limitation radio, acoustic and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 710 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer or hardware system 700. These signals, which might be in the form of electromagnetic signals, acoustic signals, optical signals, and/or the like, are all examples of carrier waves on which instructions can be encoded, in accordance with various embodiments of the invention.

The communications subsystem 730 (and/or components thereof) generally will receive the signals, and the bus 705 then might carry the signals (and/or the data, instructions, etc. carried by the signals) to the working memory 735, from which the processor(s) 705 retrieves and executes the instructions. The instructions received by the working memory 735 may optionally be stored on a storage device 725 either before or after execution by the processor(s) 710.

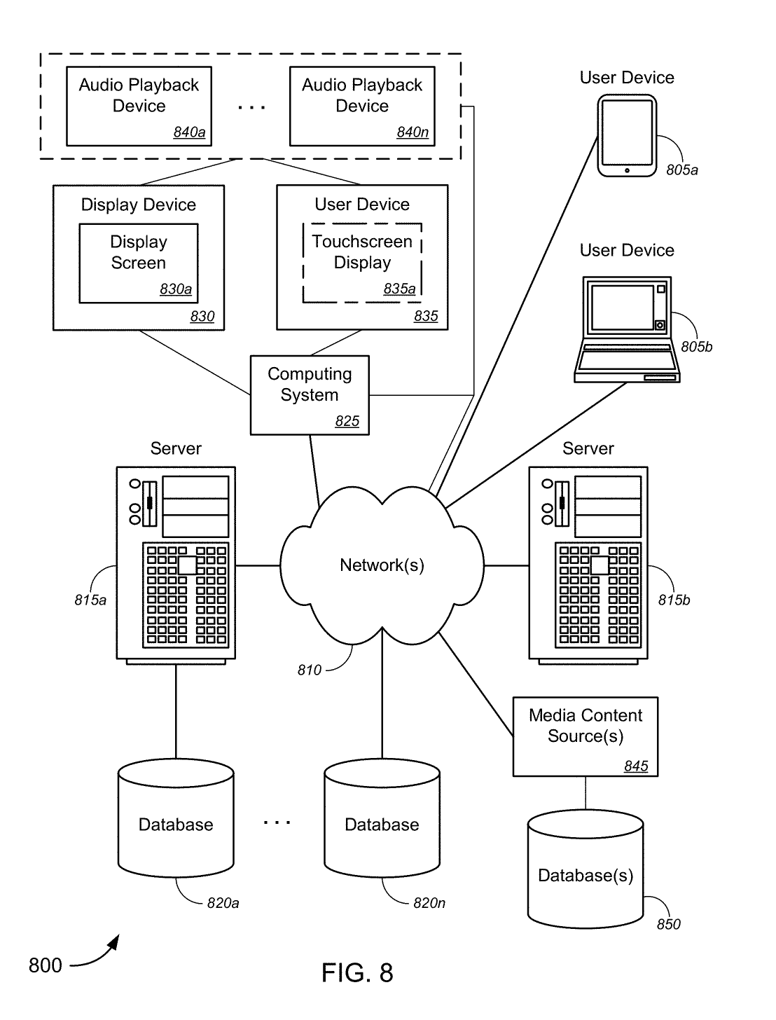

As noted above, a set of embodiments comprises methods and systems for implementing media content streaming or playback, and, more particularly, to methods, systems, and apparatuses for implementing advanced audio shifting. FIG. 8 illustrates a schematic diagram of a system 800 that can be used in accordance with one set of embodiments. The system 800 can include one or more user computers, user devices, or customer devices 805. A user computer, user device, or customer device 805 can be a general purpose personal computer (including, merely by way of example, desktop computers, tablet computers, laptop computers, handheld computers, and the like, running any appropriate operating system, several of which are available from vendors such as Apple, Microsoft Corp., and the like), cloud computing devices, a server(s), and/or a workstation computer(s) running any of a variety of commercially-available UNIX™ or UNIX-like operating systems. A user computer, user device, or customer device 805 can also have any of a variety of applications, including one or more applications configured to perform methods provided by various embodiments (as described above, for example), as well as one or more office applications, database client and/or server applications, and/or web browser applications. Alternatively, a user computer, user device, or customer device 805 can be any other electronic device, such as a thin-client computer, Internet-enabled mobile telephone, and/or personal digital assistant, capable of communicating via a network (e.g., the network(s) 810 described below) and/or of displaying and navigating web pages or other types of electronic documents. Although the exemplary system 800 is shown with two user computers, user devices, or customer devices 805, any number of user computers, user devices, or customer devices can be supported.

Certain embodiments operate in a networked environment, which can include a network(s) 810. The network(s) 810 can be any type of network familiar to those skilled in the art that can support data communications using any of a variety of commercially-available (and/or free or proprietary) protocols, including, without limitation, TCP/IP, SNA™ IPX™ AppleTalk™, and the like. Merely by way of example, the network(s) 810 (similar to network(s) 145 FIG. 1, or the like) can each include a local area network (“LAN”), including, without limitation, a fiber network, an Ethernet network, a Token-Ring™ network and/or the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including, without limitation, a network operating under any of the IEEE 802.11 suite of protocols, the Bluetooth™ protocol known in the art, and/or any other wireless protocol; and/or any combination of these and/or other networks. In a particular embodiment, the network might include an access network of the service provider (e.g., an Internet service provider (“ISP”)). In another embodiment, the network might include a core network of the service provider, and/or the Internet.

Embodiments can also include one or more server computers 815. Each of the server computers 815 may be configured with an operating system, including, without limitation, any of those discussed above, as well as any commercially (or freely) available server operating systems. Each of the servers 815 may also be running one or more applications, which can be configured to provide services to one or more clients 805 and/or other servers 815.

Merely by way of example, one of the servers 815 might be a data server, a web server, a cloud computing device(s), or the like, as described above. The data server might include (or be in communication with) a web server, which can be used, merely by way of example, to process requests for web pages or other electronic documents from user computers 805. The web server can also run a variety of server applications, including HTTP servers, FTP servers, CGI servers, database servers, Java servers, and the like. In some embodiments of the invention, the web server may be configured to serve web pages that can be operated within a web browser on one or more of the user computers 805 to perform methods of the invention.

The server computers 815, in some embodiments, might include one or more application servers, which can be configured with one or more applications accessible by a client running on one or more of the client computers 805 and/or other servers 815. Merely by way of example, the server(s) 815 can be one or more general purpose computers capable of executing programs or scripts in response to the user computers 805 and/or other servers 815, including, without limitation, web applications (which might, in some cases, be configured to perform methods provided by various embodiments). Merely by way of example, a web application can be implemented as one or more scripts or programs written in any suitable programming language, such as Java™, C, C#™ or C++, and/or any scripting language, such as Perl, Python, or TCL, as well as combinations of any programming and/or scripting languages. The application server(s) can also include database servers, including, without limitation, those commercially available from Oracle™, Microsoft™, Sybase™ IBM™, and the like, which can process requests from clients (including, depending on the configuration, dedicated database clients, API clients, web browsers, etc.) running on a user computer, user device, or customer device 805 and/or another server 815. In some embodiments, an application server can perform one or more of the processes for implementing media content streaming or playback, and, more particularly, to methods, systems, and apparatuses for implementing advanced audio shifting, as described in detail above. Data provided by an application server may be formatted as one or more web pages (comprising HTML, JavaScript, etc., for example) and/or may be forwarded to a user computer 805 via a web server (as described above, for example). Similarly, a web server might receive web page requests and/or input data from a user computer 805 and/or forward the web page requests and/or input data to an application server. In some cases, a web server may be integrated with an application server.

In accordance with further embodiments, one or more servers 815 can function as a file server and/or can include one or more of the files (e.g., application code, data files, etc.) necessary to implement various disclosed methods, incorporated by an application running on a user computer 805 and/or another server 815. Alternatively, as those skilled in the art will appreciate, a file server can include all necessary files, allowing such an application to be invoked remotely by a user computer, user device, or customer device 805 and/or server 815.

It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 820a-820n (collectively, “databases 820”). The location of each of the databases 820 is discretionary: merely by way of example, a database 820a might reside on a storage medium local to (and/or resident in) a server 815a (and/or a user computer, user device, or customer device 805). Alternatively, a database 820n can be remote from any or all of the computers 805, 815, so long as it can be in communication (e.g., via the network 810) with one or more of these. In a particular set of embodiments, a database 820 can reside in a storage-area network (“SAN”) familiar to those skilled in the art. (Likewise, any necessary files for performing the functions attributed to the computers 805, 815 can be stored locally on the respective computer and/or remotely, as appropriate.) In one set of embodiments, the database 820 can be a relational database, such as an Oracle database, that is adapted to store, update, and retrieve data in response to SQL-formatted commands. The database might be controlled and/or maintained by a database server, as described above, for example.

According to some embodiments, system 800 might further comprise a computing system 825 (similar to computing systems 105a and 105b of FIG. 1, or the like), one or more display devices 830 each with display screen 830a (similar to display devices 115 of FIG. 1, or the like), one or more user devices 835 each with touchscreen display 835a (similar to user devices 120 of FIG. 1, or the like), one or more audio playback devices 840a-840n (similar to audio playback devices 125a-125n of FIG. 1, or the like), one or more media (e.g., video) content sources 845 and corresponding database(s) 850 (similar to media or video content sources (or servers) 135 and corresponding databases 140 of FIG. 1, or the like), and/or the like. In some embodiments, the computing system might comprise a media device that is communicatively coupled to a playback device(s) (i.e., one or more of display device(s) 830, the user device(s) 105 or 835, and/or audio playback device(s) 840a-840n, or the like). In some cases, the media device might comprise one of a set-top box (“STB”), a media player, a gaming console, a server computer, a desktop computer, or a laptop computer, and/or the like. The media player might comprise one of a digital versatile disc or digital video disc (“DVD”) player, a Blu-ray disc (“BD”) player, a streaming video player, a streaming music player, or a streaming game player, and/or the like, while the playback device might comprise at least one of one or more monitors, one or more television sets, or one or more speakers, and/or the like.

In operation, one of computing system 825, display device 830, user device 835, or at least one audio playback device 840 might present a first audio content to a user using the at least one audio playback device 840. At least one of computing system 825, display device 830, user device 835, or at least one audio playback device 840 might receive user input from the user, the user input being indicative of a desire by the user to switch from presentation of the first audio content to presentation of a second audio content. In response to receiving the user input, the at least one of computing system 825, display device 830, user device 835, or at least one audio playback device 840 might automatically shift from presentation of the first audio content to presentation of the second audio content using an audio shift using the at least one audio playback device 840, the audio shift comprising a gradual decrease in volume of the first audio content to mute followed by a gradual increase in volume of the second audio content from mute. Some embodiments may approximate the gradual audio shift via a number of suitably small discrete steps in volume level change. In some embodiments, the gradual decrease in volume of the first audio content and the corresponding gradual increase in volume of the second audio content might comprise one of a mirrored pair of linear ramp waveforms, a mirrored pair of non-linear waveforms (e.g., S-curved waveforms, non-S-curved waveforms, or the like), and/or the like. In some cases, the volume of the second audio content after the gradual increase in volume might match the volume of the first audio content prior to the gradual decrease in volume. Alternatively, the volume of the second audio content after the gradual increase in volume might differ from the volume of the first audio content prior to the gradual decrease in volume.

According to some embodiments, the automatic shifting from presentation of the first audio content to presentation of the second audio content on the at least one audio playback device might be initiated after the volume of the first audio content is fully muted, while the gradual increase in volume of the second audio content might be initiated after completion of the automatic shifting from presentation of the first audio content to presentation of the second audio content on the at least one audio playback device. Alternatively, the automatic shifting from presentation of the first audio content to presentation of the second audio content on the at least one audio playback device might be initiated during the gradual decrease in volume of the first audio content and before the volume of the first audio content is fully muted, and the increase in volume of the second audio content might be initiated before the automatic shifting from presentation of the first audio content to presentation of the second audio content on the at least one audio playback device has been completed.

Merely by way of example, in some embodiments, automatically shifting from presentation of the first audio content to presentation of the second audio content using the audio shift using the audio playback device might include, without limitation, automatically shifting from presentation of the first audio content to presentation of the second audio content using one of a simple multiplication in digital domain, dithering volume control in digital domain, adjusting the gain of an amplification stage (e.g., via adjustment of suitable resistor values in an amplifier's negative feedback loop, or the like), or in the analog domain using analog switches and a stepped resistor network to implement the audio shift, and/or the like.

For embodiments in which audio shifting is implemented concurrently with video shifting (e.g., channel changing, switching between input streams in video streaming applications, switching between video content in DVR or other video recording/playback applications, and/or the like), one of computing system 825, display device 830, user device 835, or at least one audio playback device 840 might display a first video content to the user on the display device 830 while concurrently presenting (in a time/frame-matched manner) a first audio content corresponding to the first video content to the user using the at least one audio playback device 840. At least one of computing system 825, display device 830, user device 835, or at least one audio playback device 840 might receive user input from the user, the user input being indicative of a desire by the user to switch from display of the first video content to display of a second video content on the display device (and further indicative of a desire by the user to switch from presentation of the first audio content to presentation of a second audio content, which corresponds to the second video content).

In response to receiving the user input, the at least one of computing system 825, display device 830, user device 835, or at least one audio playback device 840 might automatically shift from presentation of the first audio content to presentation of the second audio content using an audio shift using the at least one audio playback device 840, the audio shift comprising a gradual decrease in volume of the first audio content to mute followed by a gradual increase in volume of the second audio content from mute. Some embodiments may approximate the gradual audio shift via a number of suitably small discrete steps in volume level change. In some embodiments, the gradual decrease in volume of the first audio content and the corresponding gradual increase in volume of the second audio content might comprise one of a mirrored pair of linear ramp waveforms, a mirrored pair of non-linear waveforms (e.g., S-curved waveforms, non-S-curved waveforms, or the like), and/or the like. In some cases, the volume of the second audio content after the gradual increase in volume might match the volume of the first audio content prior to the gradual decrease in volume. Alternatively, the volume of the second audio content after the gradual increase in volume might differ from the volume of the first audio content prior to the gradual decrease in volume. Further in response to receiving the user input, the at least one of computing system 825, display device 830, user device 835, or at least one audio playback device 840 might automatically shift from display of the first video content to display of the second video content on the display device, concurrent with automatically shifting from presentation of the first audio content to presentation of the second audio content using the audio shift using the audio playback device.

According to some embodiments, the automatic shifting from display of the first video content to display of the second video content on the display device might be initiated after the volume of the first audio content is fully muted, while the gradual increase in volume of the second audio content might be initiated after completion of the automatic shifting from display of the first video content to display of the second video content on the display device. Alternatively, the automatic shifting from display of the first video content to display of the second video content on the display device might be initiated during the gradual decrease in volume of the first audio content and before the volume of the first audio content is fully muted, and the increase in volume of the second audio content might be initiated before the automatic shifting from display of the first video content to display of the second video content on the display device has been completed.

Merely by way of example, in some embodiments, automatically shifting from presentation of the first audio content to presentation of the second audio content using the audio shift using the audio playback device might include, without limitation, automatically shifting from presentation of the first audio content to presentation of the second audio content using one of a simple multiplication in digital domain, dithering volume control in digital domain, adjusting the gain of an amplification stage (e.g., via adjustment of suitable resistor values in an amplifier's negative feedback loop, or the like), or in the analog domain using analog switches and a stepped resistor network to implement the audio shift, and/or the like.

These and other functions of the system 800 (and its components) are described in greater detail above with respect to FIGS. 1-6.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A method, comprising:
presenting, with a computing system, a first audio content to a user using an audio playback device;
receiving, with the computing system, user input from the user, the user input being indicative of a desire by the user to switch from presentation of the first audio content to presentation of a second audio content; and
in response to receiving the user input, automatically shifting, with the computing system, from presentation of the first audio content to presentation of the second audio content using an audio shift using the audio playback device, the audio shift comprising a gradual decrease in volume of the first audio content to mute followed by a gradual increase in volume of the second audio content from mute.

2. The method of claim 1, wherein the gradual decrease in volume of the first audio content and the corresponding gradual increase in volume of the second audio content comprise one of a mirrored pair of linear ramp waveforms, a mirrored pair of S-curved waveforms, or a mirrored pair of non-S-curved waveforms.

3. The method of claim 1, wherein the volume of the second audio content after the gradual increase in volume matches the volume of the first audio content prior to the gradual decrease in volume.

4. The method of claim 1, further comprising:
displaying, with the computing system, a first video content to the user on a display device, the first audio content corresponding to the first video content, wherein the user input is further indicative of a desire by the user to switch from display of the first video content to display of a second video content on the display device, the second audio content corresponding to the second video content; and
further in response to receiving the user input, automatically shifting, with the computing system, from display of the first video content to display of the second video content on the display device, concurrent with automatically shifting from presentation of the first audio content to presentation of the second audio content using the audio shift using the audio playback device.

5. The method of claim 4, wherein the automatic shifting from display of the first video content to display of the second video content on the display device is initiated during the gradual decrease in volume of the first audio content and before the volume of the first audio content is fully muted.

6. The method of claim 4, wherein the automatic shifting from display of the first video content to display of the second video content on the display device is initiated after the volume of the first audio content is fully muted, and wherein the gradual increase in volume of the second audio content is initiated after completion of the automatic shifting from display of the first video content to display of the second video content on the display device.

7. The method of claim 4, wherein each of the first video content and the second video content comprise one of video content that is broadcast on a broadcast channel or video content among a plurality of video content available for browsing or viewing in one of a video on demand (“VoD”) platform, a video streaming platform, or a digital video recording (“DVR”) platform.

8. The method of claim 1, wherein automatically shifting from presentation of the first audio content to presentation of the second audio content using the audio shift using the audio playback device comprises automatically shifting, with the computing system, from presentation of the first audio content to presentation of the second audio content using one of a simple multiplication in digital domain, dithering volume control in digital domain, adjusting the gain of an amplification stage, or in the analog domain using analog switches and a stepped resistor network to implement the audio shift.

9. The method of claim 1, wherein the computing system comprises one of a processor of a set-top box, a processor of a digital video recording (“DVR”) device, a processor of a display device running a software application (“app”), a processor of the audio playback device, a processor on a user device running an app, a processor of a media player, a processor of a gaming console, a processor in sound studio audio equipment, a processor in video editing equipment, a processor in broadcast equipment, a processor in a video head-end, a processor in audio equipment associated with a sound reinforcement installation, a processor in audio equipment associated with a public address system, a server computer over a network, or a cloud-based computing system over a network.

10. The method of claim 1, wherein the audio playback device comprises one or more speakers external to but communicatively coupled to a display device, one of one or more speakers of the display device, one or more speakers external to but communicatively coupled to the computing system, one or more speakers of the computing system, one or more speakers external to but communicatively coupled to a user device, one or more speakers of the user device, one or more headphones, one or more earbuds, one or more sound bars, one or more wireless speakers, or one or more stereo speakers.

11. An apparatus, comprising:
at least one processor; and
a non-transitory computer readable medium communicatively coupled to the at least one processor, the non-transitory computer readable medium having stored thereon computer software comprising a set of instructions that, when executed by the at least one processor, causes the apparatus to:
present a first audio content to a user using an audio playback device;
receive user input from the user, the user input being indicative of a desire by the user to switch from presentation of the first audio content to presentation of a second audio content; and
in response to receiving the user input, automatically shift from presentation of the first audio content to presentation of the second audio content using an audio shift using the audio playback device, the audio shift comprising a gradual decrease in volume of the first audio content to mute followed by a gradual increase in volume of the second audio content from mute.

12. The apparatus of claim 11, wherein the gradual decrease in volume of the first audio content and the corresponding gradual increase in volume of the second audio content comprise one of a mirrored pair of linear ramp waveforms, a mirrored pair of S-curved waveforms, or a mirrored pair of non-S-curved waveforms.

13. The apparatus of claim 11, wherein the volume of the second audio content after the gradual increase in volume matches the volume of the first audio content prior to the gradual decrease in volume.

14. The apparatus of claim 11, wherein the set of instructions, when executed by the at least one processor, further causes the apparatus to:
display a first video content to the user on a display device, the first audio content corresponding to the first video content, wherein the user input is further indicative of a desire by the user to switch from display of the first video content to display of a second video content on the display device, the second audio content corresponding to the second video content; and
further in response to receiving the user input, automatically shift from display of the first video content to display of the second video content on the display device, concurrent with automatically shifting from presentation of the first audio content to presentation of the second audio content using the audio shift using the audio playback device.

15. The apparatus of claim 14, wherein the automatic shifting from display of the first video content to display of the second video content on the display device is initiated during the gradual decrease in volume of the first audio content and before the volume of the first audio content is fully muted.

16. The apparatus of claim 14, wherein the automatic shifting from display of the first video content to display of the second video content on the display device is initiated after the volume of the first audio content is fully muted, and wherein the gradual increase in volume of the second audio content is initiated after completion of the automatic shifting from display of the first video content to display of the second video content on the display device.

17. The apparatus of claim 14, wherein the display device comprises one of a television set, a smart television, a computer monitor, or a laptop monitor.

18. The apparatus of claim 11, wherein automatically shifting from presentation of the first audio content to presentation of the second audio content using the audio shift using the audio playback device comprises automatically shifting from presentation of the first audio content to presentation of the second audio content using one of a simple multiplication in digital domain, dithering volume control in digital domain, adjusting the gain of an amplification stage, or in the analog domain using analog switches and a stepped resistor network to implement the audio shift.

19. The apparatus of claim 11, wherein the apparatus comprises one of a set-top box, a digital video recording (“DVR”) device, a display device running a software application (“app”), the audio playback device, a user device running an app, a media player, a gaming console, sound studio audio equipment, video editing equipment, broadcast equipment, a video head-end, audio equipment associated with a sound reinforcement installation, audio equipment associated with a public address system, a server computer over a network, or a cloud-based computing system over a network.

20. The apparatus of claim 11, wherein the audio playback device comprises one or more speakers external to but communicatively coupled to a display device, one of one or more speakers of the display device, one or more speakers external to but communicatively coupled to the computing system, one or more speakers of the computing system, one or more speakers external to but communicatively coupled to a user device, one or more speakers of the user device, one or more headphones, one or more earbuds, one or more sound bars, one or more wireless speakers, or one or more stereo speakers.

21. A system, comprising:
a computing system, comprising:
at least one first processor; and
a first non-transitory computer readable medium communicatively coupled to the at least one first processor, the first non-transitory computer readable medium having stored thereon computer software comprising a first set of instructions that, when executed by the at least one first processor, causes the computing system to:
send a first audio content to an audio playback device; and
the audio playback device, comprising:
one or more speakers;
at least one second processor; and
a second non-transitory computer readable medium communicatively coupled to the at least one second processor, the second non-transitory computer readable medium having stored thereon computer software comprising a second set of instructions that, when executed by the at least one second processor, causes the audio playback device to:
receive the first audio content from the computing system; and
present the first audio content to a user using the one or more speakers;
wherein the first set of instructions, when executed by the at least one first processor, further causes the computing system to:
receive user input from the user, the user input being indicative of a desire by the user to switch from presentation of the first audio content to presentation of a second audio content; and
in response to receiving the user input, send command instructions to the audio playback device to automatically shift from presentation of the first audio content to presentation of the second audio content using an audio shift and send the second audio content to the audio playback device; and
wherein the second set of instructions, when executed by the at least one first processor, further causes the audio playback device to:
receive the command instructions from the computing system;
receive the second audio content from the computing system; and
in response to receiving the command instructions, automatically shift from presentation of the first audio content to presentation of the second audio content using the audio shift using the one or more speakers, the audio shift comprising a gradual decrease in volume of the first audio content to mute followed by a gradual increase in volume of the second audio content from mute.

22. The system of claim 21, wherein the gradual decrease in volume of the first audio content and the corresponding gradual increase in volume of the second audio content comprise one of a mirrored pair of linear ramp waveforms, a mirrored pair of S-curved waveforms, or a mirrored pair of non-S-curved waveforms.

23. The system of claim 21, wherein the volume of the second audio content after the gradual increase in volume matches the volume of the first audio content prior to the gradual decrease in volume.

24. The system of claim 21, further comprising:
a display device, comprising:
a display screen;
at least one third processor; and
a third non-transitory computer readable medium communicatively coupled to the at least one third processor, the third non-transitory computer readable medium having stored thereon computer software comprising a third set of instructions that, when executed by the at least one third processor, causes the display device to:
display a first video content to the user on a display device, the first audio content corresponding to the first video content, wherein the user input is further indicative of a desire by the user to switch from display of the first video content to display of a second video content on the display device, the second audio content corresponding to the second video content; and
further in response to receiving the user input, automatically shift from display of the first video content to display of the second video content on the display device, concurrent with automatically shifting from presentation of the first audio content to presentation of the second audio content using the audio shift using the audio playback device.

25. The system of claim 24, wherein the automatic shifting from display of the first video content to display of the second video content on the display device is initiated during the gradual decrease in volume of the first audio content and before the volume of the first audio content is fully muted.

26. The system of claim 24, wherein the automatic shifting from display of the first video content to display of the second video content on the display device is initiated after the volume of the first audio content is fully muted, and wherein the gradual increase in volume of the second audio content is initiated after completion of the automatic shifting from display of the first video content to display of the second video content on the display device.

27. The system of claim 21, wherein automatically shifting from presentation of the first audio content to presentation of the second audio content using the audio shift using the audio playback device comprises automatically shifting from presentation of the first audio content to presentation of the second audio content using one of a simple multiplication in digital domain, dithering volume control in digital domain, adjusting the gain of an amplification stage, or in the analog domain using analog switches and a stepped resistor network to implement the audio shift.

28. The system of claim 21, wherein the computing system comprises one of a set-top box, a digital video recording (“DVR”) device, a display device running a software application (“app”), the audio playback device, a user device running an app, a media player, a gaming console, sound studio audio equipment, video editing equipment, broadcast equipment, a video head-end, audio equipment associated with a sound reinforcement installation, audio equipment associated with a public address system, a server computer over a network, or a cloud-based computing system over a network.

29. The system of claim 21, wherein the audio playback device comprises one or more speakers external to but communicatively coupled to a display device, one of one or more speakers of the display device, one or more speakers external to but communicatively coupled to the computing system, one or more speakers of the computing system, one or more speakers external to but communicatively coupled to a user device, one or more speakers of the user device, one or more headphones, one or more earbuds, one or more sound bars, one or more wireless speakers, or one or more stereo speakers.
